(19) United States
(12) Patent Application Publication
(10) Pub. No.: US 2013/0185912 A1
(43) Pub. Date: Jul. 25, 2013

(54) RECONFIGURABLE MOUNTING HEAD

(71) Applicant: Grifiti LLC, Jackson, WY (US)

(72) Inventor: Andrew Lee Choy, San Francisco, CA (US)

(73) Assignee: GRIFITI LLC, Jackson, WY (US)

(21) Appl. No.: 13/684,839

(22) Filed: Nov. 26, 2012

Related U.S. Application Data
(60) Provisional application No. 61/563,748, filed on Nov. 26, 2011.

(51) Int. Cl. F16B 17/00

(52) U.S. Cl. CPC F16B 17/00
USPC 29/426.2; 403/66

(57) ABSTRACT

A multipoint reconfigurable system and method supporting a wide-variety of configurations that permit adaptation of the mounting system to the user's specific needs. The present invention includes embodiments directed towards multipoint connection bodies, monolegs, flexlegs, lanyard heads, secure connectors, snap connectors, and combinations thereof as well improved structures and methods for implementing these systems and methods. A reversible monopod includes a telescoping columnar monopod body including a proximal end and a distal end; and a coupler coupled to each the end, the coupler selected from the group consisting of a quick-connect type 1 coupler, a quick-connect type 2 coupler complementary to the quick-connect type 1 coupler, a threaded ¼-20 stud connector, and combinations thereof.

### CROSS REFERENCE TO RELATED APPLICATIONS

This application claims the benefit of U.S. Provisional Application No. 61/563,748, filed 26 Nov. 2011, the contents of which are expressly incorporated by reference thereto in its entirety for all purposes.

### BACKGROUND OF THE INVENTION

The present invention relates generally to a device mounting apparatus and more specifically but not exclusively to an apparatus and method for a reversible monopod optionally including a multipoint reconfigurable system including one or more multipoint attachment bodies and one or more interconnectable elements (rigid and flexible) with the flexible elements including shape-retaining shafts for engaging, holding and pointing “things” (typically portable electronic objects including imaging devices including cameras or video recorders, communication devices including smartphones, and computing systems including tablet computers, supporting accessories, and the like).

U.S. Pat. No. 7,798,452, hereby expressly incorporated herein in its entirety, describes an early generation multiuse device mounting system and method. During development and implementation, additional features and advances have increased the versatility and usefulness of the original system. The present application describes some of these additional enhanced features and advances.

Portability is an important characteristic of many devices in use today, and in many cases the usefulness of the device is directly related to its efficiency in a portable mode. One particular class of device for which this is true is the class of imaging devices including portable devices with imaging features. This class includes portable cameras of all sorts including digital cameras and video cameras, including those incorporated into smartphones and tablet computers. These portable cameras range widely in size from the very small to the barely portable. Common uses of the portable camera include applications requiring particularly steady positioning and operation as well as remote operation. Other classes of devices include portable display devices and portable computing devices.

The camera art has developed the tripod as a mounting system for engaging and holding the portable camera. It satisfies the requirements of providing a platform for steady positioning and operation, and permits easy remote operation. Many different tripods have been developed to address concerns with size and weight, as well as to adapting a camera to an imaging environment.

Tripods have an inherent disadvantage in that they require a stable, nearly planar surface upon which to be set up. Telescoping legs make the tripod somewhat adaptable to uneven surfaces. It is often the case that the more complex and adaptable the tripod is, the more inconvenient and difficult it is to setup. The more inconvenient and difficult it is to setup a tripod inhibits its use notwithstanding its usefulness.

The art has seen solutions to some of the drawbacks of the tripod, such as the requirement for a suitable, nearly flat, stable surface upon which to setup. One solution has been to mount a camera to the tripod, then lash the tripod to another nearby object using separate cords such as one or more bungee cords.

While the camera art has developed standards for mounting connectors (e.g., a standard ¼″ 20 threaded bolt and complementary threaded socket), including a standard threaded female socket is installed in the body of most modern imaging devices, including low cost versions, other portable devices that could be used with a multiuse mounting system do not come pre-equipped with such standard mounting systems.

A further point to consider in the camera and imaging art is that the operator typically has many different accessories that, in certain circumstances, must be used in cooperation with the imaging activity to achieve desired results. Many of these accessories are independently adjustable and correct positioning relative to the imaging device achieves can achieve superior results.

Included in the collection of accessory/mounting system is a monopod (or unipod) that is useful in some contexts to allow an imager to record an image at slower shutter speeds and/or with longer focal length lenses. Incorporation of a monopod into a collection of a multiuse mounting system components is better in the event that the monopod itself has enhanced features and characteristics, increasing its value in a collection of accessories.

What is needed is a monopod for use with a multipoint reconfigurable system and method that supports a wide-variety of configurations that permit adaptation of the mounting system to the user's specific needs.

### BRIEF SUMMARY OF THE INVENTION

Disclosed is a monopod for use with a multipoint reconfigurable system and method that supports a wide-variety of configurations that permit adaptation of the mounting system to the user's specific needs. The present invention includes embodiments directed towards multipoint connection bodies, monolegs, flexlegs, lanyard heads, secure connectors, snap connectors, and combinations thereof as well improved structures and methods for implementing these systems and methods.

In the incorporated patent, the disclosure included reference to a standardized mounting system consistent across many different connectors and uses to provide a generalized multipurpose mounting system. As different implementations and applications would have different needs and requirements, no particular connector system was particularly highlighted or additional details of some preferred embodiments for specific implementations.

Disclosed are multiconnection bodies that include three or more points of attachment on a support body, with each of the attachment points being a male connector or a complementary female connector and the attachment points including an underside connection point, a lateral connection point and a topside connection point.

Disclosed is a combination of a monopod and one or more flexlegs coupled to a multiconnection body. Preferably the monopod is a telescoping straight, rigid member having a male connector attachment point at a proximal end for engaging the center underside female connector on the multiconnection body and a female connector attachment point at a distal end for receiving a desired foot with an attachment point supporting a male connector.

Disclosed is a combination of a set of tripod legs and one or more flexlegs coupled to a multiconnection body. Preferably the tripod legs include a telescoping straight, rigid member having a male connector attachment point at a rotatable oblique coupler disposed at a proximal end for engaging the non-center female connectors on the multiconnection body (either the three underside connector or the three lateral connectors) and a female connector attachment point at each distal end for receiving a desired foot with an attachment point supporting a male connector.

Disclosed is a three-type multi-method mounting system for use in easily converting the mounted portable device from a desired “pod” mode to a carrying mode, particularly when used with the system and methods disclosed herein, including the multiconnection point body, universal connector system, and other compatible components and accessories.

Disclosed are a set of attachment point terminators that are used to enhance functionality by coupling to a connector at one of the many attachment points. Using connectors from the universal connector system enables a user to supplement and extend the inherent functionality of the system and method. In some cases, the attachment point terminators are feet (e.g., posts, spikes, balls, suction pads, magnetic structures and the like), adapters, couplers, and the like.

Disclosed herein are two specific universal connector systems that are useable on the various attachment points, including body attachment points, leg (flexible, straight, or combination) attachment points, feet attachment points, and adapter attachment points. A universal connector system used at these attachment points provides an enhanced multipoint mount experience. The universal connector systems include a snap-connector system and a locking rotator connector system. Unless the context suggests otherwise, the various universal connector systems are considered interchangeable (though not necessarily inter-matable) with respect to the attachment points described herein.

Disclosed is a reversible monopod includes a telescoping columnar monopod body including a proximal end and a distal end; and a coupler coupled to each the end, the coupler selected from the group consisting of a quick-connect type 1 coupler, a quick-connect type 2 coupler complementary to the quick-connect type 1 coupler, a threaded ¼″/-20 stud connector, and combinations thereof.

Disclosed is a reversible monopod system includes a reversible monopod having a telescoping columnar monopod body including a proximal end and a distal end; and a coupler coupled to each the end, the coupler selected from the group consisting of a quick-connect type 1 coupler, a quick-connect type 2 coupler complementary to the quick-connect type 1 coupler, a threaded ¼″-20 stud connector, and combinations thereof; and a support coupled to the proximal end of the telescoping columnar body above a support surface, the support having a first support mode and a second support mode, the first support mode directing the telescoping columnar body in a generally downward direction from the proximal end towards the support surface and the second support mode directing the telescoping columnar body in a generally upward direction from the proximal end away from the support surface.

Disclosed is a mounting method including a) attaching an object coupler to a coupler at a proximal end of a telescoping columnar monopod body; and b) attaching a terminator to a coupler at a distal end of the telescoping columnar monopod body; and thereafter c) detaching the object coupler; d) detaching the terminator; and thereafter e) attaching the object coupler to the coupler at the distal end of the telescoping columnar monopod body.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a side view of a multipoint reconfigurable system;

FIG. 2 illustrates a side view of the multipoint reconfigurable system shown in FIG. 1 with component parts detached from underside and topside connectors;

FIG. 3 illustrates a top perspective view of the multipoint reconfigurable system shown in FIG. 2;

FIG. 4 illustrates a top perspective view of the multipoint reconfigurable system shown in FIG. 1 reconfigured with the flexlegs attachable to lateral connectors;

FIG. 5 illustrates a perspective view of an optional sleeve for the flexlegs used with the multipoint reconfigurable system;

FIG. 6 illustrates a side view of the optional sleeve shown in FIG. 5;

FIG. 7 illustrates a sectional view of the optional sleeve shown in FIG. 6;

FIG. 8 illustrates a top plan view of a flexleg assembly;

FIG. 9 illustrates a top perspective view of the flexleg assembly shown in FIG. 8;

FIG. 10 illustrates a side plan view of the flexleg assembly shown in FIG. 8;

FIG. 11 illustrates a top perspective view of a body of the multipoint reconfigurable system shown in FIG. 1 through FIG. 4;

FIG. 12 illustrates a top perspective view of the body shown in FIG. 11 with components of the male connector of the snapping universal connector system exploded out;

FIG. 13 illustrates a top plan view of the body shown in FIG. 11;

FIG. 14 illustrates a bottom plan view of the body shown in FIG. 11;

FIG. 15 illustrates a side plan view of the body shown in FIG. 11;

FIG. 16 illustrates a side plan view of the body shown in FIG. 15 rotated ninety degrees about a vertical axis;

FIG. 17 illustrates a bottom perspective view of the body shown in FIG. 11;

FIG. 18 illustrates a top perspective view of a stacked set of a second type of body;

FIG. 19 illustrates bottom perspective view of the stacked set of bodies shown in FIG. 18;

FIG. 20 illustrates a top plan view of the stacked set of bodies shown in FIG. 18;

FIG. 21 illustrates a side plan view of the stacked set of bodies shown in FIG. 18;

FIG. 22 illustrates a side plan view of the stacked set of bodies shown in FIG. 21 rotated about the vertical axis;

FIG. 23 illustrates a top perspective view of a stacked set of a third type of body;

FIG. 24 illustrates a side plan view of the stacked set of bodies shown in FIG. 23;

FIG. 25 illustrates a top plan view of the stacked set of bodies shown in FIG. 23;

FIG. 26 illustrates a top perspective view of stacked set of a fourth type of body;

FIG. 27 illustrates a side plan view of a monopod mounting system including a basic monopod and a multipoint attachment body;

FIG. 28 illustrates a top perspective view of the system shown in FIG. 27;

FIG. 29 illustrates a top perspective view of a second monopod mounting system including a basic monopod and a multipoint attachment body and further including a plurality of flexlegs;

FIG. 30 illustrates a top perspective view of a third monopod mounting system including a basic monopod and a multipoint attachment body and further including a plurality of flexpods;

FIG. 31 illustrates a front plan view of the system shown in FIG. 30;

FIG. 32 illustrates a side plan view of the system shown in FIG. 30;

FIG. 33 illustrates a side plan view of a monopod mounting system including a basic monopod and a multipoint attachment body and further including a plurality of flexpods;

FIG. 34 illustrates a front plan view of the system shown in FIG. 33;

FIG. 35 illustrates a rear plan view of a tripod leg, including a rotating-oblique-connector, for use with a multipoint attachment body;

FIG. 36 illustrates a side plan view of the tripod leg of FIG. 35;

FIG. 37 illustrates a top perspective view of a first tripod mounting system including three tripod legs and a multipoint attachment body;

FIG. 38 illustrates a side plan view of the tripod mounting system shown in FIG. 37;

FIG. 39 illustrates a front plan view of the tripod mounting system shown in FIG. 37;

FIG. 40 illustrates a top plan view of the tripod mounting system shown in FIG. 37;

FIG. 41 illustrates a front view of a second tripod mounting system including the first tripod mounting system modified by addition of a flexpod and a lightmount coupler;

FIG. 42 illustrates a rear plan view of the second tripod mounting system shown in FIG. 41;

FIG. 43 illustrates a front view of a third tripod mounting system including the first tripod mounting system modified by addition of three lateral flexpods;

FIG. 44 illustrates a rear plan view of the third tripod mounting system;

FIG. 45 illustrates a side plan view of the third tripod mounting system;

FIG. 46 illustrates a front perspective view of a reconfigured third tripod mounting system;

FIG. 47 illustrates an exploded perspective view of a modified object coupler;

FIG. 48 illustrates a perspective view of a modified object coupler as shown in FIG. 47 for example;

FIG. 49 illustrates a top plan view of a modified object coupler as shown in FIG. 47 for example;

FIG. 50 illustrates a sectional view of a modified object coupler as shown in FIG. 47 for example;

FIG. 51 illustrates a bottom plan view of a modified object coupler as shown in FIG. 47 for example;

FIG. 52 illustrates a perspective view of a lanyard terminator assembly;

FIG. 53 illustrates a front plan view of the lanyard terminator assembly shown in FIG. 49;

FIG. 54 illustrates a side plan view of the lanyard terminator assembly shown in FIG. 49;

FIG. 55 illustrates a top plan view of the lanyard terminator assembly shown in FIG. 49;

FIG. 56 is a perspective view of a representative strap for use with the multipoint reconfigurable system described herein;

FIG. 57 illustrates a perspective view of a magnetic terminator assembly;

FIG. 58 illustrates a front plan view of the magnetic terminator assembly shown in FIG. 57;

FIG. 59 illustrates a top plan view of the magnetic terminator assembly shown in FIG. 57;

FIG. 60 illustrates a perspective view of a suction-foot terminator assembly;

FIG. 61 illustrates a front plan view of the suction-foot terminator assembly shown in FIG. 60;

FIG. 62 illustrates a side plan view of the suction-foot terminator assembly shown in FIG. 60;

FIG. 63 illustrates a top plan view of the suction-foot terminator assembly shown in FIG. 60;

FIG. 64 illustrates a perspective view of the lightmount coupler introduced in FIG. 41;

FIG. 65 illustrates a top plan view of the lightmount coupler;

FIG. 66 illustrates a front plan view of the lightmount coupler;

FIG. 67 illustrates a side plan view of the lightmount coupler;

FIG. 68 illustrates a perspective view of a flash mount coupler;

FIG. 69 illustrates a top plan view of the flash mount coupler;

FIG. 70 illustrates a front plan view of the flash mount coupler;

FIG. 71 illustrates a side plan view of the flash mount coupler;

FIG. 72 illustrates a perspective view of a type 2 to type 2 coupler;

FIG. 73 illustrates a top plan view of the type 2 to type 2 coupler;

FIG. 74 illustrates a front plan view of the type 2 to type 2 coupler;

FIG. 75 illustrates a side plan view of the type 2 to type 2 coupler;

FIG. 76 illustrates a perspective view of a type 1 to type 1 coupler;

FIG. 77 illustrates a top plan view of the type 1 to type 1 coupler;

FIG. 78 illustrates a front plan view of the type 1 to type 1 coupler;

FIG. 79 illustrates a side plan view of the type 1 to type 1 coupler;

FIG. 80 illustrates a perspective view of a magnetic mount coupler;

FIG. 81 illustrates a top plan view of the magnetic mount coupler;

FIG. 82 illustrates a front plan view of the magnetic mount coupler;

FIG. 83 illustrates a side plan view of the magnetic mount coupler;

FIG. 84 illustrates a front perspective view of a type 1 coupler from a quick connect snap universal connector system;

FIG. 85 illustrates a top plan view of the type 1 coupler shown in FIG. 84;

FIG. 86 illustrates a front plan view of the type 1 coupler shown in FIG. 84;

FIG. 87 illustrates a side plan view of the type 1 coupler shown in FIG. 84;

FIG. 88 illustrates a front perspective view of a type 2 coupler from the quick connect snap universal connector system;

FIG. 89 illustrates a top plan view of the type 2 coupler shown in FIG. 88;

FIG. 90 illustrates a front plan view of the type 2 coupler shown in FIG. 88;

FIG. 91 illustrates a side plan view of the type 2 coupler shown in FIG. 88;

FIG. 92 illustrates a front perspective view of a type 1 coupler from a quick connect twist universal connector system;

FIG. 93 illustrates a top plan view of the type 1 coupler shown in FIG. 92;

FIG. 94 illustrates a side plan view of the type 1 coupler shown in FIG. 92;

FIG. 95 illustrates a front plan view of the type 1 coupler shown in FIG. 92;

FIG. 96 illustrates a front perspective view of a type 2 coupler from the quick connect twist universal connector system;

FIG. 97 illustrates a top plan view of the type 2 coupler shown in FIG. 96;

FIG. 98 illustrates a side plan view of the type 2 coupler shown in FIG. 96;

FIG. 99 illustrates a front plan view of the type 2 coupler shown in FIG. 96;

FIG. 100 illustrates a perspective view of a coupler ring assembly for the quick connect twist connector;

FIG. 101 illustrates a perspective exploded view of the coupler ring assembly of FIG. 100;

FIG. 102 illustrates a front plan view of the coupler ring assembly of FIG. 100;

FIG. 103 illustrates a first sectional view of coupler ring assembly of FIG. 100;

FIG. 104 illustrates a second sectional view of the coupler ring assembly of FIG. 100;

FIG. 105 illustrates a perspective view of a flexleg element;

FIG. 106 illustrates a front plan view of the flexleg element shown in FIG. 105;

FIG. 107 illustrates a side plan view of the flexleg element shown in FIG. 105;

FIG. 108 illustrates a sectional view of the flexleg element shown in FIG. 107;

FIG. 109 illustrates a plan view of a tripod system reconfigured to carry an object;

FIG. 110 illustrates a general schematic of a reversible monopod;

FIG. 111 illustrates a first configuration mode for a reversible monopod system using the reversible monopod shown in FIG. 110;

FIG. 112 illustrates a second configuration mode for the reversible monopod system shown in FIG. 111;

FIG. 113 illustrates a perspective view of a three-legged tripod arrangement for the monopod support system in the first configuration mode;

FIG. 114 illustrates a perspective view of a three-legged tripod arrangement for the monopod support system in the second configuration mode; and

FIG. 115 illustrates a perspective view of the three-legged tripod arrangement shown in FIG. 113 and FIG. 114 without installation of the monopod.

### DETAILED DESCRIPTION OF THE INVENTION

Embodiments of the present invention provide an apparatus and method for a monopod for use with a multipoint reconfigurable system and method that supports a wide-variety of configurations that permit adaptation of the mounting system to the user's specific needs. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the discussion herein regarding the preferred embodiments, unless the context suggests otherwise, the elements of the preferred embodiments are applicable to a broad range of portable devices and are not limited to cameras or digital video recorders (DVRs), but rather many portable devices, more particularly portable electronic devices including cameras, DVRs, smartphones, Tablet computers, related accessories (flash mounts, glare screens, grips, and the like), and the like may be the object or one of several objects used in cooperation with the multipoint reconfigurable systems described herein.

One of the advantages of the systems and methods described herein is the use of cooperative elements that each have one or more attachment points that support connectors from a common, or compatible, quick connect universal connector system. While one preferred use of these systems and methods is with photography as a substitute for tripod/monopods, there are a number of issues that are advantageously solved when implementing a quick connect solution to imaging device support apparatus. One hallmark of imaging with such support apparatus is enhanced stability as it is undesirable to introduce motion artifacts into an image, particularly due to sloppiness or instability in the mounting hardware or the connections between components (which is one reason that many supporting solutions do not include quick connectors for structural components responsible for locating, holding, and pointing the imaging device as they can, unless designed and built properly, introduce the undesirable motion artifacts and other problems). Special attention is required for the connectors in a quick connect solution to imaging support apparatus. These types of connectors are notorious for introducing sloppiness at the point of connection because of the way that the a connector and its complement engage each other. The sloppiness comes from designs that have tolerances to enable the connectors to quickly engage and disengage, but while engaged, these tolerances often produce the instability that is undesirable for an imaging solution. One way that the preferred implementations of the connectors enhance stability in the mating of connectors is to provide the connectors with ramped mating surfaces that additionally include a polygonal perimeter.

Additionally, the more that the flexible elements used in the reconfigurable solutions described herein achieve one of the important goals of smooth transition from one pointing orientation to another and can maintain the particular orientations set by the user, the more useful that solution is. Thus sloppiness in the element positioning of the flexlegs is undesirable as it interferes with true positioning/pointing as a user does not want to deal with positioning hysteresis (where a user has to overshoot the actual orientation so that “relaxation” of the support elements may return the actual orientation to the intended final orientation). The more that the actual orientation can simply match the intended orientation, without repositioning or any sign of instability in the established orientation of the elements (which is a function of the accumulated sloppiness of the connections and support elements) the more satisfactory is the solution. The flexlegs and connectors are potential sources of this instability, particularly in a multipoint reconfigurable system that has the potential to apply many connections and flexible/rigid elements for an imaging/pointing implementation.

General

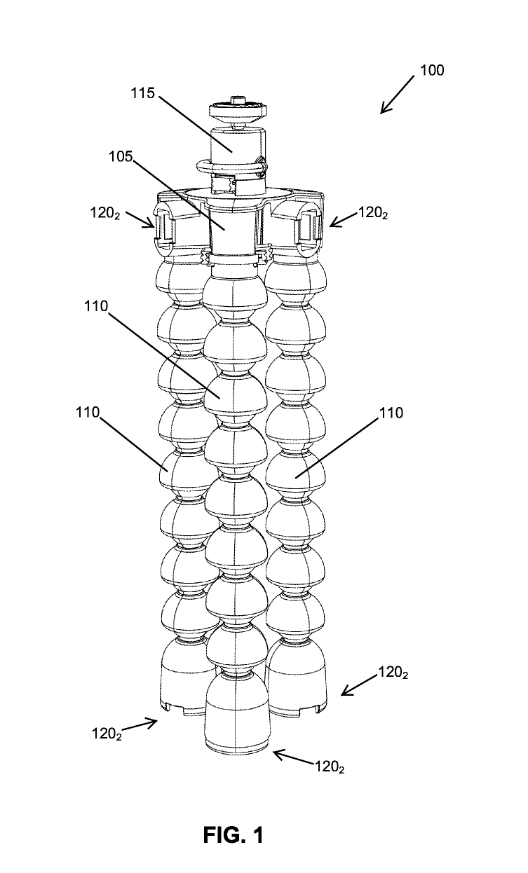

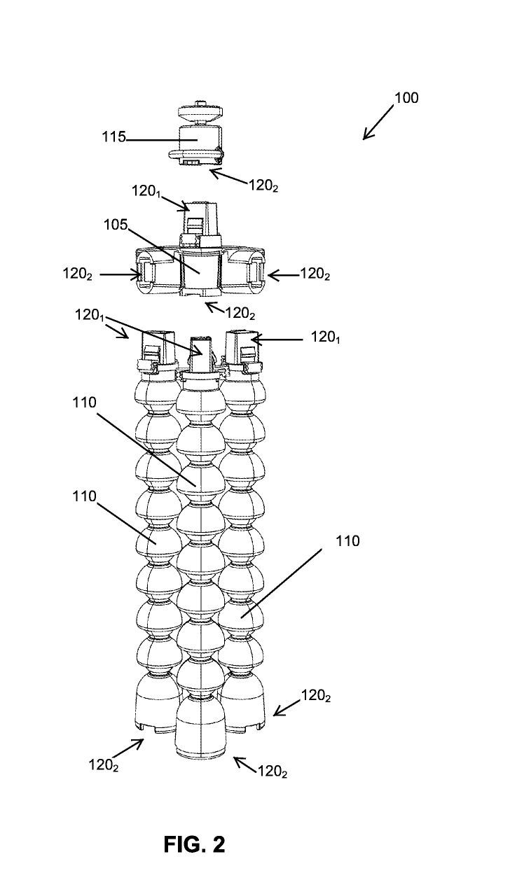

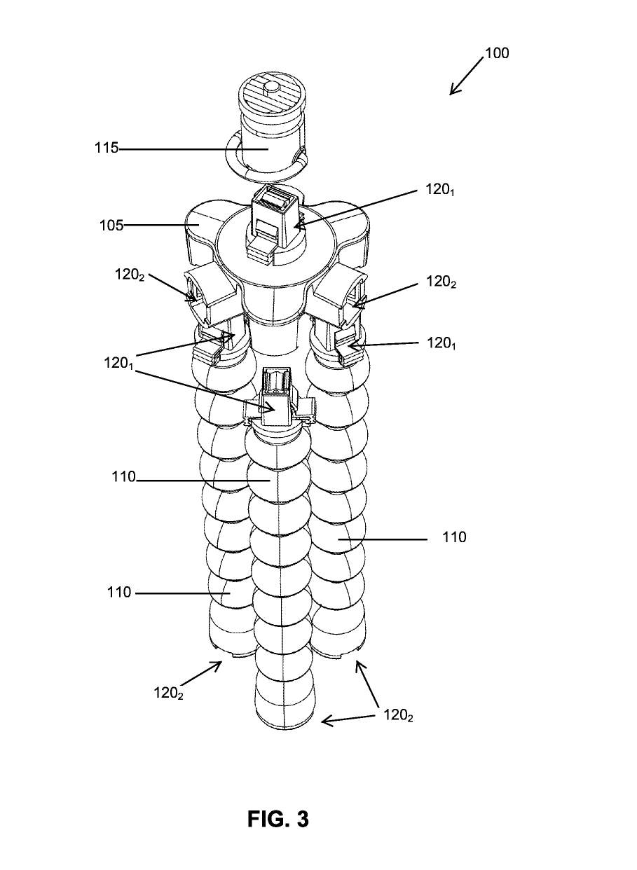

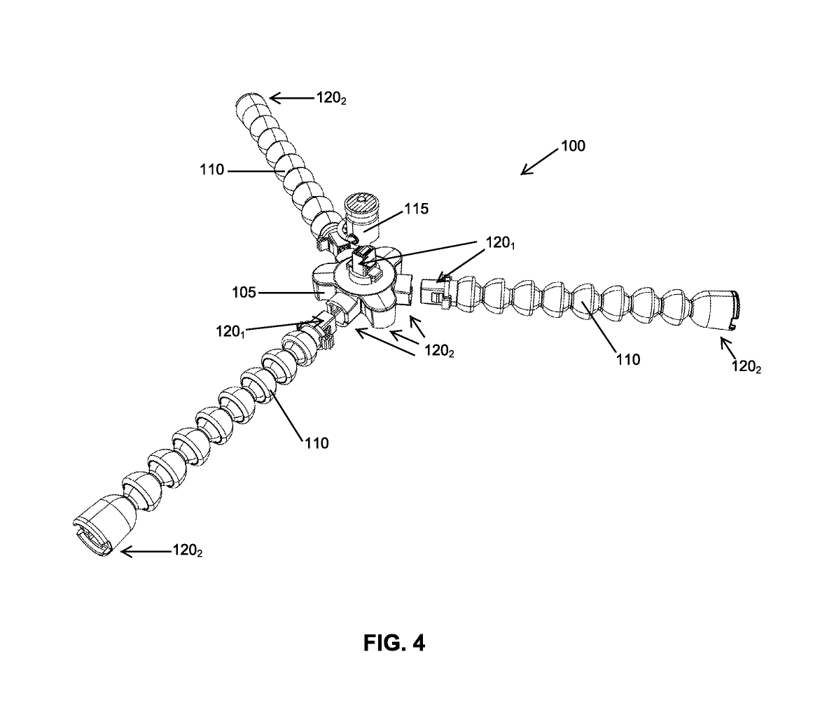

FIG. 1 illustrates a side view of a multipoint reconfigurable system (MRS) 100. FIG. 2 illustrates a side view of MRS 100 shown in FIG. 1 with component parts detached from underside connectors; FIG. 3 illustrates a top perspective view of MRS 100 shown in FIG. 1; and FIG. 4 illustrates a top perspective view of the multipoint reconfigurable system shown in FIG. 1 reconfigured with the flexlegs attachable to lateral connectors. MRS 100 includes a multipoint attachment body 105, a plurality of flexlegs 110, and an object coupler 115.

Multipoint attachment body 105 is further described below. In general multipoint attachment body 105, each flexleg 110, and object coupler 115 include one or more attachment points 120 strategically positioning connectors from a universal connector system that are inter/intra-compatible with a wide-range of system elements that enable a user to implement and use an efficiently assembled customized mounting system and to quickly re-configure that system as the needs of the user change. For example, in comparison to the simple case of a conventional tripod, a user is no longer confined to just adjusting leg height, leg separation distance, and camera mount height, or for that matter, using a three-legged ‘pod for mounting.

As described elsewhere herein, multipoint attachment body 105 preferably includes eight or more attachment points 120 (4 on an underside surface, 3 on lateral surfaces, and at least one on an upper surface). Additionally, attachment points 120 are provided at proximal and distal ends of each flexleg 110, and on a surface of object coupler 115. At these attachment points 120 are disposed connectors from a particular universal connector system that includes one or more coupler types: typically a type 1 coupler (e.g., a male connector); and a compatible complementary type 2 coupler (e.g., a matching female socket). In the figures, it may not be always convenient or clear to simultaneously highlight attachment points and the particular coupler/connector disposed at the attachment point. In the figures herein, the following convention is adopted—that wherever an attachment point is indicated, a coupler from a universal connector system is preferably disposed (in general the particular type may vary from that shown) and wherever a coupler is indicated, an attachment point is inherently provided. Further, the following convention is also adopted: an attachment point that preferably (but not necessarily requires) a type 1 coupler is indicated as attachment point 120₁ while an attachment point that preferably (but not necessarily requires) a type 1 coupler is indicated as attachment point 120₂. Described herein are particular arrangements and orientations for attachment points 120 and for the type of coupler chosen from a particular connector system. The present invention includes other implementations and embodiments having different arrangements and orientations, sometimes with different connectors and different connector systems, and in some cases, couplers from multiple connector systems.

Described herein are two preferred universal “quick” connector systems: a snap connector system, and a twist connector system. Largely, couplers from the two connector systems are incompatible, but in some implementations, it is desirable to enable a cross-coupling of connectors from the connector systems, though sometimes with reduced functionality as compared to intra-coupling of connectors all from one connector system. For example, a type 2 coupler from the twist connector system may accept type 1 couplers from the snap connector system.

As used herein, attachment point 120 describes a location where a connector is provided. In some cases, a particular type of connector is preferred at particular locations and at other times, any type of connector may be used. In the preferred embodiment, multipoint attachment body 105 includes at least three attachment points 120 on an underside surface, with type 2 couplers disposed at these locations. These three attachment points 120 are but one way that MRS 100 may be configured into a tripod mode, by engaging one flexleg 110 at each of these three attachment points 120.

Each flexleg 110 is preferably fungible, having both a proximal end and a distal end. Each end includes an attachment point 120, preferably a type 1 coupler at the proximal end and a type 2 coupler at the distal end, the couplers chosen from, or compatible with, the same universal connector system employed by couplers at the attachment points 120 of multipoint attachment body 105.

Flexleg 110 is a flexible assembly that is constructed to be bent, twisted, coiled, draped, wrapped, torsioned, curved, bowed, arched, curled, spiraled, and/or turned into a desired configuration while having a shape-retaining resilience appropriate for the particular application to resist to the desired degree, some tensioning forces, some compression forces, some bending forces, and some torsioning forces as a user is able to change the shape of a flexleg 110 without undue effort. Flexleg 110, by virtue of complementary connectors at opposing ends, is able to be serially coupled to one or more other flexlegs 110, forming an elongated flexleg chain that collectively serve and function as an extended flexleg. Desirably each flexleg 110 (including extended flexlegs) are able to support their weight, and any supported element/device without self-alteration of its configuration, such as due to gravity. Flexleg 110 (and extended flexlegs) may individually mount at any available attachment point by virtue of each flexleg 110 including both a type 1 coupler and a type 2 coupler from the universal connector system.

Flexleg 110 preferably is assembled from a series of interconnected flexleg elements that enable the described features and function. In a preferred embodiment, each flexleg element of flexleg 110 optionally includes an exterior surface portion that includes a gripping surface that exhibits a high coefficient of friction when contacting a wide-range of materials.

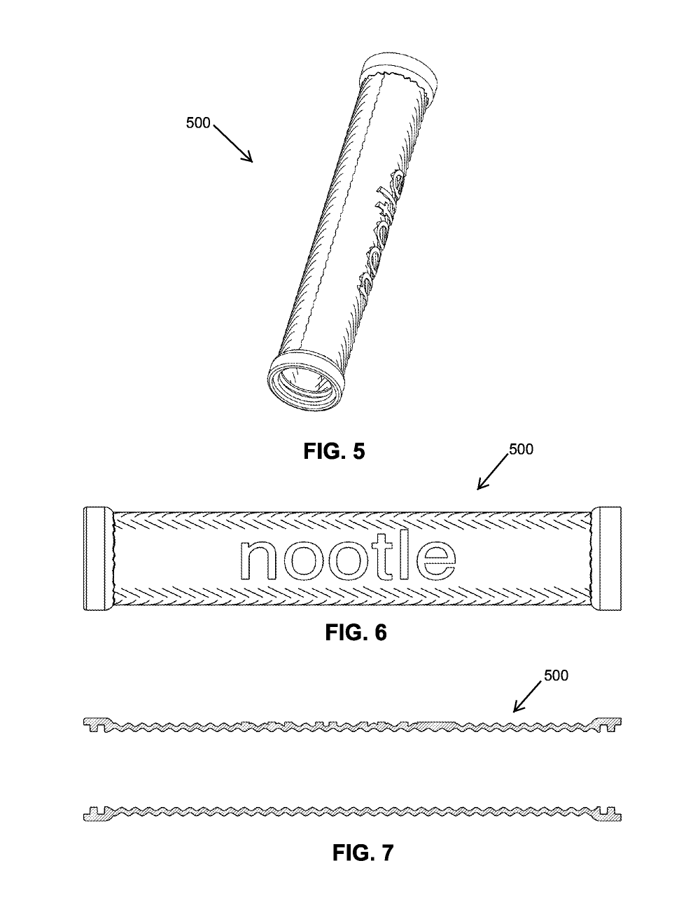

FIG. 5 illustrates a perspective view of an optional sleeve 500 for the flexlegs used with multipoint reconfigurable system 100. FIG. 6 illustrates a side view of optional sleeve 500 shown in FIG. 5 and FIG. 7 illustrates a sectional view of optional sleeve 500 The optional sleeve is sized and shaped to encase flexleg 110 along its entire length. Sleeve 500 is configured of a flexible resilient material designed to offer the same high coefficient of friction when contacting a wide-range of materials as indicated as an optional gripping surface for each flexleg element. This enhances the gripping action and simplifies construction of the flexleg elements.

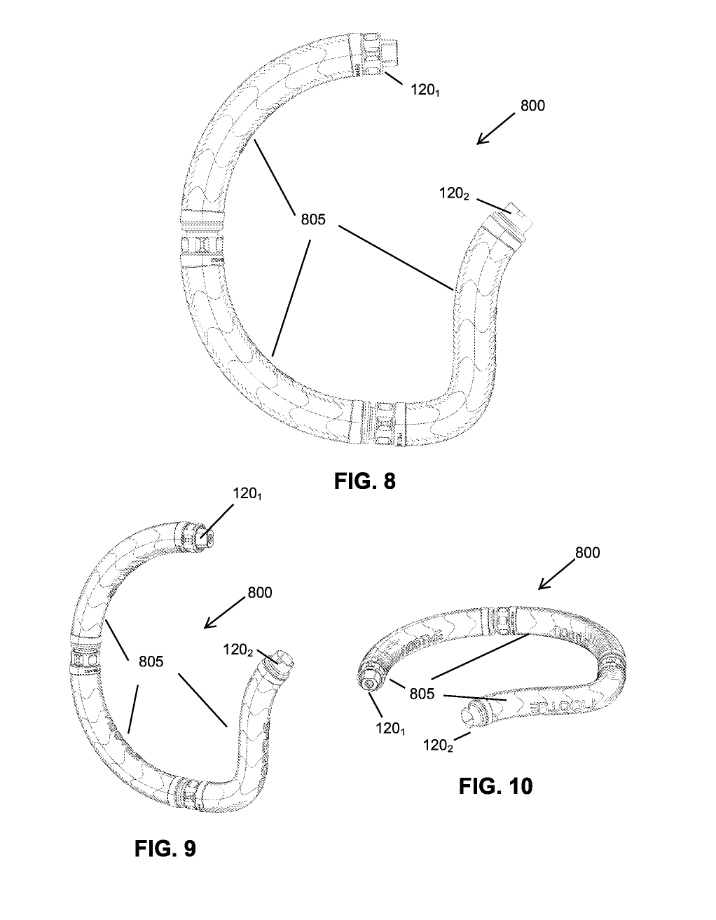

FIG. 8 illustrates a top plan view of an assembly 800 including three series-connected flexleg assemblies, each flexleg assembly referred to herein as a flexpod 805, each flexpod 805 including a flexleg 110 and an overlying sleeve 500. FIG. 9 illustrates a top perspective view of assembly 800 and FIG. 10 illustrates a side plan view of assembly 800. In the context of the present invention, flexlegs 110 and flexpods 805 are interchangeable, unless the context or express statement to the contrary appears.

Multiconnection Bodies

Multiconnection bodies of the preferred embodiments include three or more points of attachment on a support body, with each of the attachment points provided with a type 1 coupler (e.g., a male connector) or a complementary type 2 coupler (e.g., a female connector) and the attachment points including underside attachment points, lateral attachment points, and topside attachment points. Even more preferably, there are more than five attachment points, at least three on the underside, at least one on a lateral wall, and at least one on the topside, and still more preferably, seven or more attachment points, with four on the underside (three attachment points distributed around an underside perimeter and one center attachment point), at least two lateral attachment points, and at least one centered topside attachment point. Most preferably, there are at least four female attachment points on the underside, three female attachment points evenly distributed around the lateral wall, and at least one male attachment point centered on the topside.

In addition to other advantages, the preferred arrangement for a multipoint attachment body enables body stacking, with a particular coupler (e.g., a type 1 coupler) at the topside attachment point engaging a complementary coupler (e.g., a type 2 coupler) at the center underside attachment point to present a stacked multipoint attachment body with at least eleven attachment points, including: four underside attachment points on the bottom-most body of the stack, six lateral attachment points (three on each of the bottom-most body and three on the top-most body), and at least one attachment point on the topside of the top-most body.

In some embodiments, a relative arrangement of the center underside female attachment point and the center topside male attachment point results in a relative rotation of the lateral attachment points as each body is stacked. In other words, the lateral attachment points are offset from one another when comparing lateral attachment points on one body versus lateral attachment points on a body included in a stack of bodies. Further details are provided herein, including the FIG. 11-FIG. 25 and the descriptions thereof.

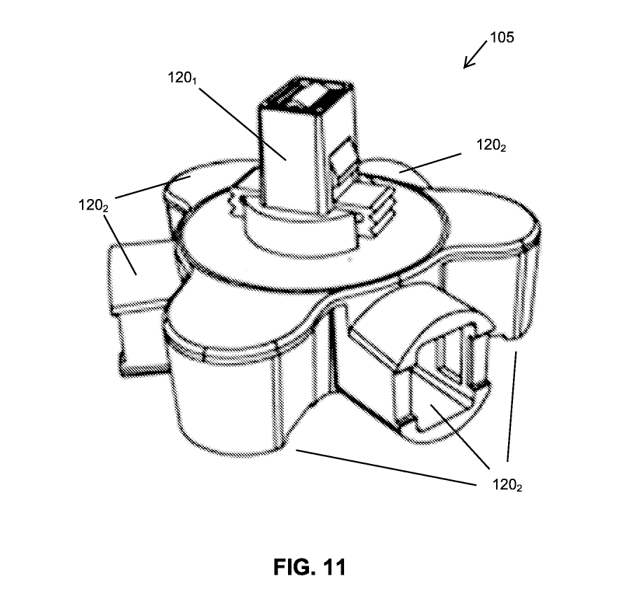

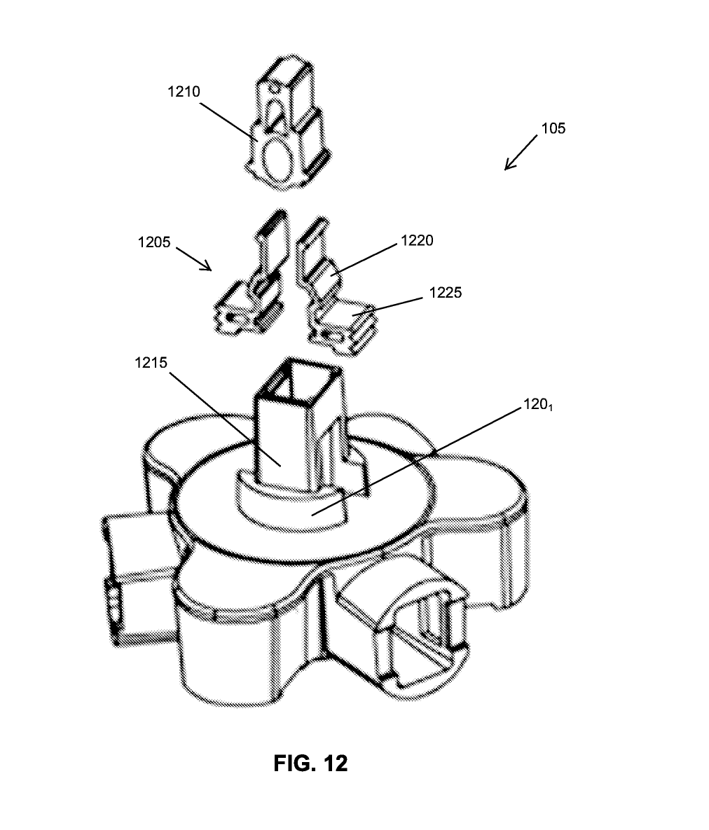

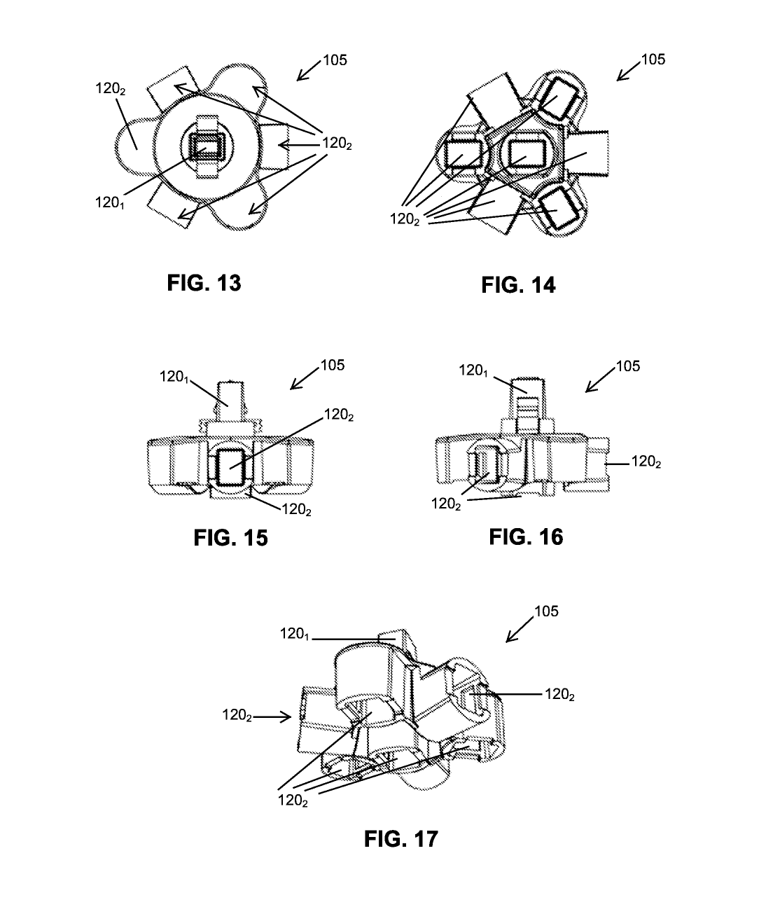

FIG. 11 illustrates a top perspective view of multipoint attachment body 105 of the multipoint reconfigurable system 100 shown in FIG. 1 through FIG. 4. FIG. 12 illustrates a top perspective view of multipoint attachment body 105 with components of a type 1 coupler of the universal snap connector system exploded out; FIG. 13 illustrates a top plan view of multipoint attachment body 105; FIG. 14 illustrates a bottom plan view of multipoint attachment body 105; FIG. 15 illustrates a side plan view of multipoint attachment body 105; FIG. 16 illustrates a side plan view of multipoint attachment body 105 shown in FIG. 15 rotated ninety degrees about a vertical axis; and FIG. 17 illustrates a bottom perspective view of multipoint attachment body 105.

FIG. 12 includes a pair of latching springs 1205 and a retainer 1210 that are disposed within a rectilinear frustum 1215 that collectively form a type 1 coupler for the snap connector system. Latching springs 1205 each include a locking tab 1220 and a connector release tab 1225. With the pair of latching springs 1205 and retainer 1210 installed within frustum 1215, the pair of locking tabs 1220 and release tabs 1225 extend exterior of frustum 1215. As further described in detail later, locking tabs 1220 engage complementary recesses within a snap type 2 coupler and operation of release tabs 1225 allow disengagement of the snap type 1 coupler from a snap type 2 coupler.

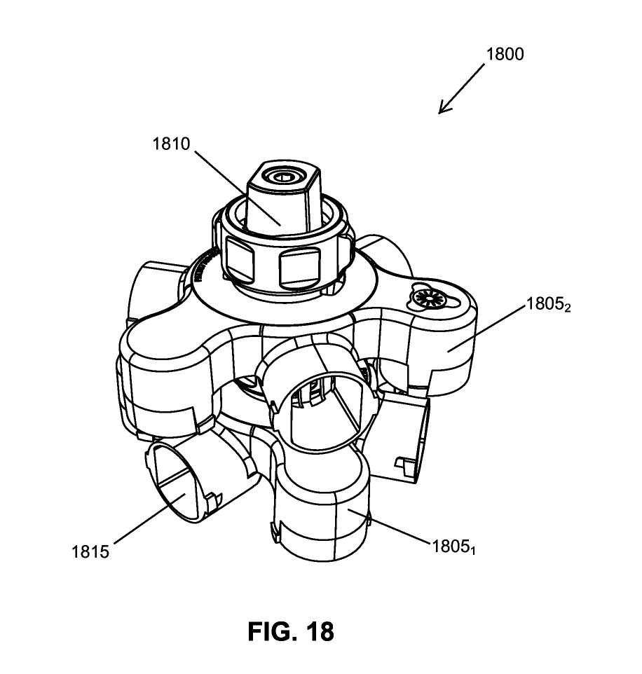

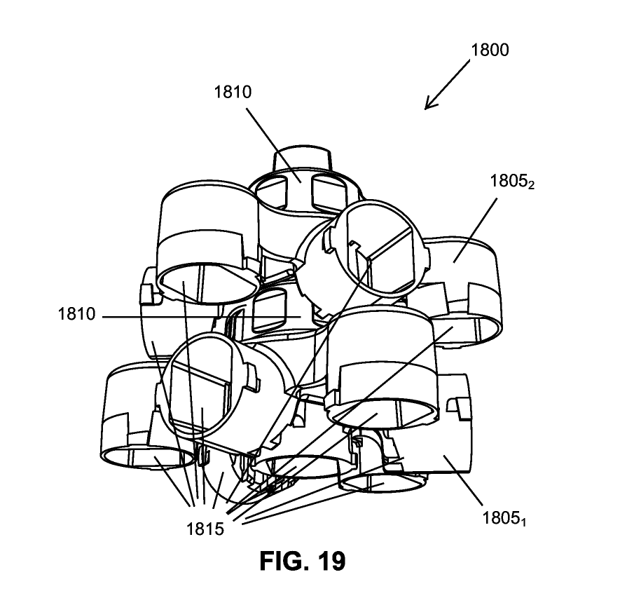

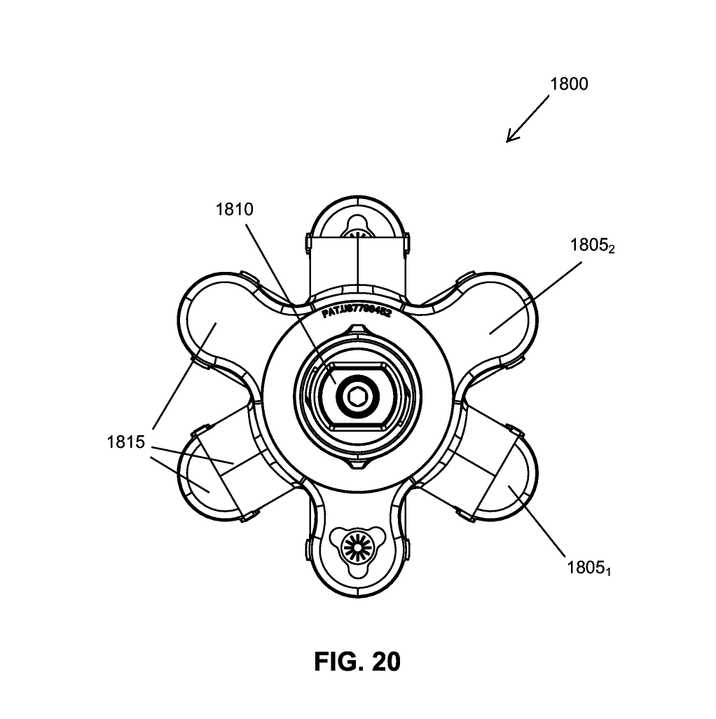

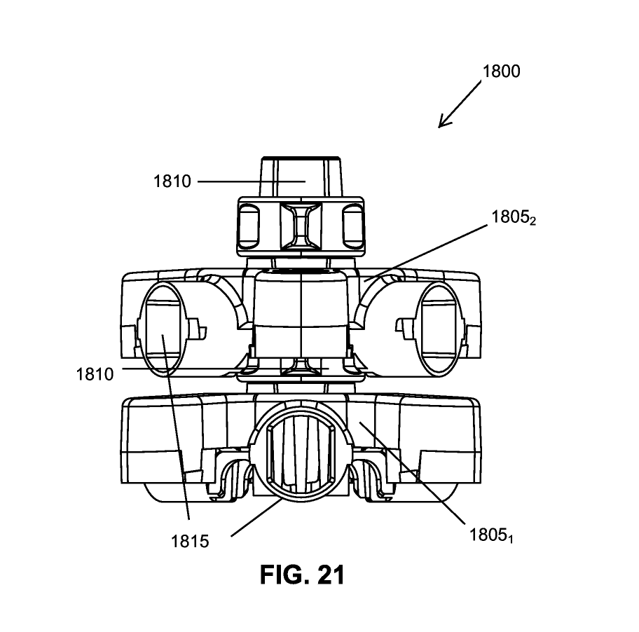

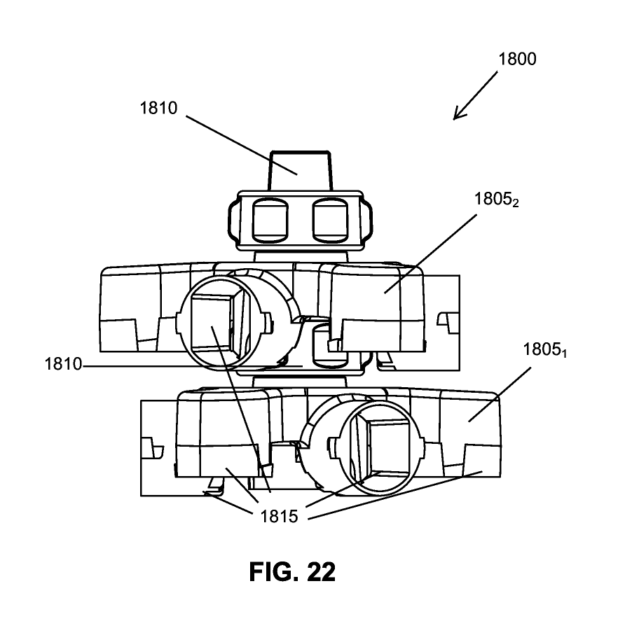

FIG. 18 illustrates a top perspective view of a stacked set 1800 of a second type of a multipoint attachment body 1805; FIG. 19 illustrates a bottom perspective view of stacked set 1800; FIG. 20 illustrates a top plan view of stacked set 1800; FIG. 21 illustrates a side plan view of stacked set 1800; and FIG. 22 illustrates a side plan view of stacked set 1800 shown in FIG. 21 rotated about the vertical axis. Multipoint attachment body 1805 may be similarly implemented as multipoint attachment body 105, preferably with the same arrangement of attachment points, and therefore may be used interchangeably, provided that accessories and other cooperating elements employ connectors from the same, or compatible, universal connector system as used with multipoint attachment body 1805. Where multipoint attachment body 105 employed connectors from the snap universal connector system at the identified attachment points 120, multipoint attachment body 1805 is shown with connectors from the twist universal connector system. As further described herein, both connector systems are “quick connect” type systems.

For stacking, it is preferred that there by “centered” attachment points that support complementary and compatible couplers from the quick connect universal connector systems. In this context, centered preferably refers to center-of-gravity so that a multipoint attachment body may be easily supported by an element coupled to a center underside attachment point. In other contexts center may refer to a physical center that is equidistant from points on the perimeter, a point of symmetry, a centroid, a center of mass, a center of rotation, or otherwise as the context suggests, and for many implementations, these centers may identify the same general location.

For example, stacked set 1800 includes a type 1 coupler that is a quick connect male twist connector 1810 that is complementary to any of a plurality of type 2 couplers disposed at lateral and underside attachment points, each of which is a quick connect female twist connector 1815. Multipoint attachment body 1805 is configured to impart a relative effective rotation of sixty degrees between each level of stacking. This relative effective rotation between levels of stacking is set by the different number of orientations that quick connect male twist connector 1810 of an underlying level is able to engage quick connect female twist connector 1815 of an overlying level AND the relative orientation of quick connect female twist connector 1815 to other attachment points 120 on the same multipoint attachment body 1805. (Note that in the figures, not all of the attachment points are expressly referenced to simplify the figures as each multipoint attachment body 1805 includes eight attachment points and referencing all attachment points in every figure could obscure other important features.)

The connectors of multipoint attachment body 1805 having mating surfaces arranged about a rectangular perimeter that provides two degrees of freedom for mating. The type 1 coupler may be engaged in a first orientation, or a second orientation that is 180° different. Some couplers, for example those using a triangular perimeter, may offer three different orientations that are 120° different from one another. (Similarly square perimeters, pentagonal, octagonal perimeters may be implemented and offer different degrees of freedom when mating the connectors. A circular perimeter would offer virtually an unlimited number of possible angular orientations.) Limitations on the perimeter relate to the specifics of the engagement elements and the desired level of anti-rotation resistance, among other considerations. For example, the snap connectors lend themselves to a rectangular perimeter for efficient packing within a circular form factor to enable the releasable opposing latching system as described herein. Twist connectors may employ almost any desired perimeter profile.

As shown for stacked set 1800, a first multipoint attachment body 1805₁ may be oriented so that a second overlying multipoint attachment body 1805₂ has its attachment points disposed in different directions (as noted, corresponding lateral and underside attachment points sixty degrees different). Stacked set 1800 allows unlimited stacking, with each added multipoint attachment body 1805 adding additional lateral attachment points (in this case, three lateral attachment points added per additional multipoint attachment body 1805).

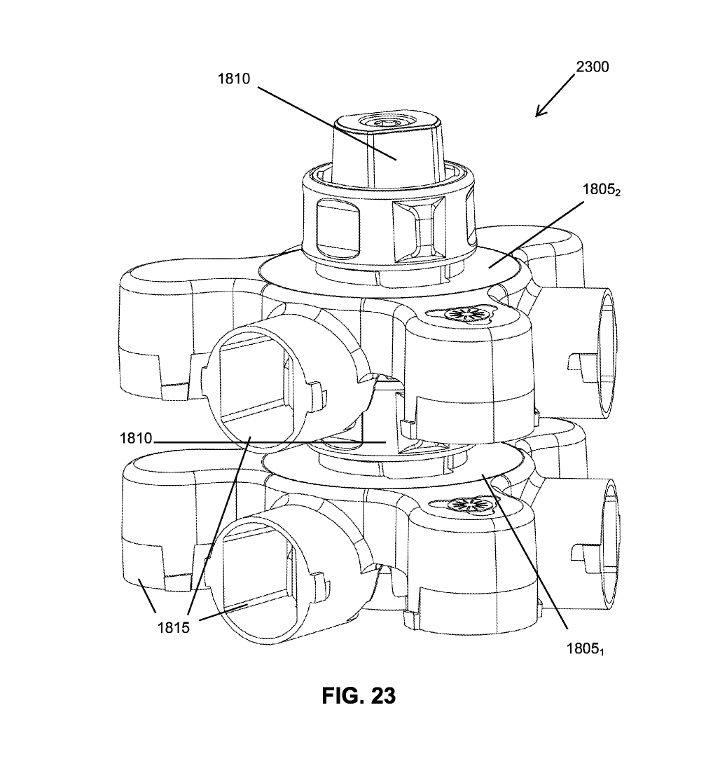

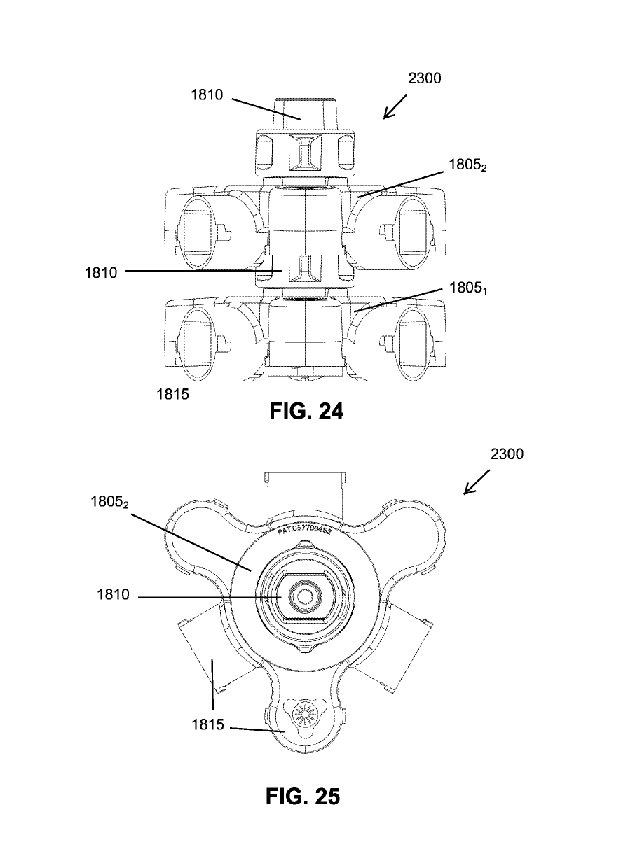

FIG. 23 illustrates a top perspective view of a stacked set 2300 of multipoint attachment body 1805; FIG. 24 illustrates a side plan view of stacked set 2300; and FIG. 25 illustrates a top plan view of the stacked set of bodies shown in FIG. 23. Stacked set 2300 is similar to stacked set 1800 except that multipoint attachment body 1805 is rotated 180° differently to align attachment points on successive levels. Consequently, first multipoint attachment body 1805₁ is not visible in FIG. 25.

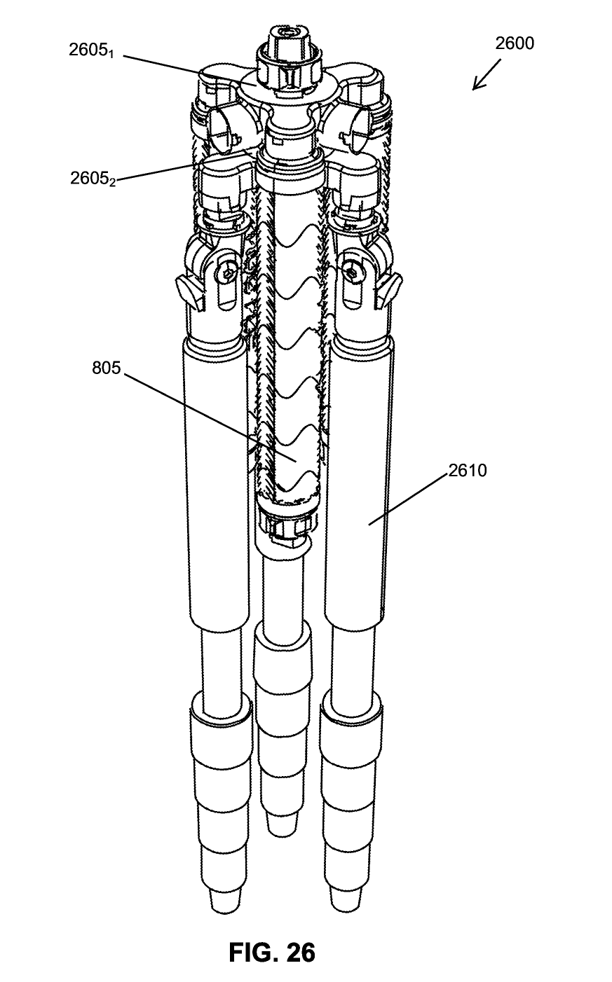

FIG. 26 illustrates a top perspective view of a stacked set 2600 of a fourth type of multipoint attachment body 2605. Each multipoint attachment body 2605 preferably includes eight attachment points including a top center attachment point for a type 1 coupler, three lateral attachment points for type 2 couplers, and four underside attachment points (one centered and three evenly distributed non-centered attachment points) for type 2 couplers, the couplers all chosen from the same or complementary universal connector system. In this way, two multipoint attachment bodies 2605 may stack as shown and form stacked set 2600. Multipoint attachment body 2605 includes the feature that the non-centered attachment points of a “top” multipoint attachment body 2605₁ are configured such that they are accessible in stacked set 2600 having two multipoint attachment bodies 2605 and are not blocked by a “bottom” multipoint attachment body 2605₂. This enables an efficient packing/storage/carrying configuration in which bottom multipoint attachment body 2605₂ has all four underside attachment points exposed and may have a monopod leg (not shown in FIG. 26 but described elsewhere herein) coupled to the centered underside attachment points, and up to three legs (e.g., flexpod 805 and/or a tripod leg 2610, further described elsewhere herein) coupled to the three non-centered underside attachment points. At the same time, up to three additional mounting elements/accessories (for example, three flexpods 805) may be coupled to the three non-centered underside attachment points of top multipoint attachment body 2605₁. In this way, up to seven legs (a combination of flexpod, monopod, and/or tripod legs) are efficiently attached and stored for rapid redeployment/reconfiguration into a wide range of configurations, some of which are described herein. Three lateral attachment points and the topside attachment point of top multipoint attachment body 2605₁ are also available for other attachment, such as for example, other legs, terminators, or the like. This has several advantages, including that major structural components are conveniently and efficiently packed and nested, enabling easy storage and carrying of stacked stet 2600.

Monopod-Flexleg Combination

Disclosed is a combination of a monopod and one or more flexpods coupled to a multiconnection body. Preferably the monopod is a telescoping straight, rigid member having an attachment point for a type 1 coupler at a proximal end for engaging a center underside type 2 coupler on a multipoint attachment body and, optionally, an attachment point for a type 2 coupler at a distal end for receiving a desired terminator with an attachment point supporting a type 1 coupler. In this way, individual legs may separately coupled to couplers at any unused attachment points, such as on the multipoint attachment body (e.g., the non-centered underside attachment points or the lateral attachment points), coupled together in series fashion for an extended flexpod, or a combination thereof when multiple flexpods are employed. The flexpods may be used to help maintain a desired orientation for the monopod (e.g., lashing to a third object), help hold equipment in a desired position (e.g., equipment with attachment points having connectors from the universal connector system, for example, type 1 couplers), or a combination thereof.

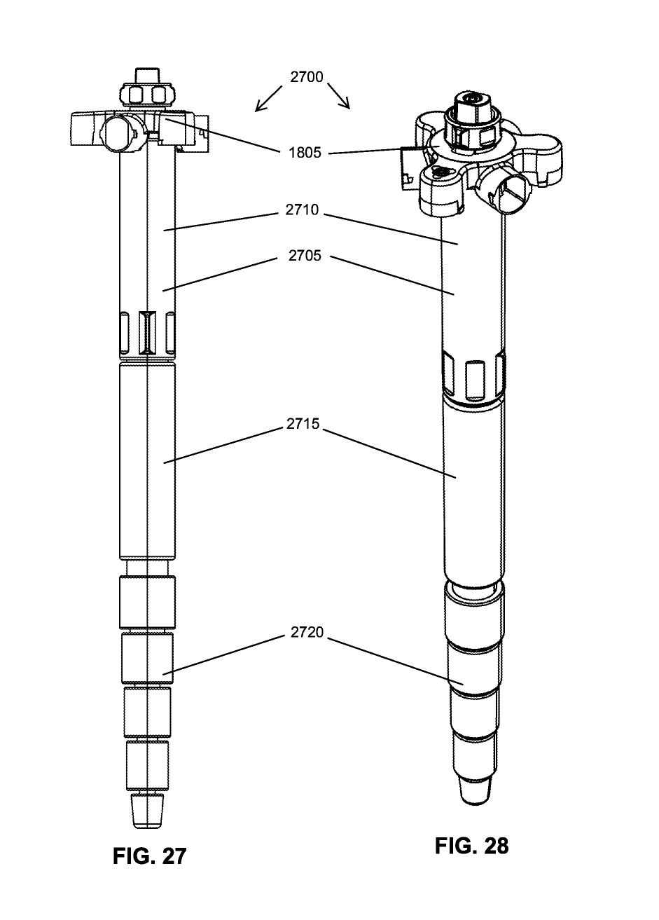

FIG. 27 illustrates a side plan view of a monopod mounting system 2700 including a basic monopod 2705 and a multipoint attachment body, such as multipoint attachment body 1805. FIG. 28 illustrates a top perspective view of monopod mounting system 2700. Monopod 2705 includes an upper body 2710, a lower body 2715, and a telescoping body 2720, all coupled together forming a rigid, linear, telescoping, locking, monopod 2705.

Upper body 2710 is used as a grip, such as with one hand, to hold, move, position, and operate monopod mounting system 2700. A length of monopod 2705 is controlled by extending/retracting telescoping body 2720. Telescoping body 2720 is locked and locked by operation of a locking mechanism that is controlled by relative rotation between upper body 2710 and lower body 2715. A user grips both upper body 2710 and lower body 2715 in different hands and relatively twists them in opposing directions with one relative direction locking telescoping body 2720 and with another relative direction unlocking telescoping body 2720.

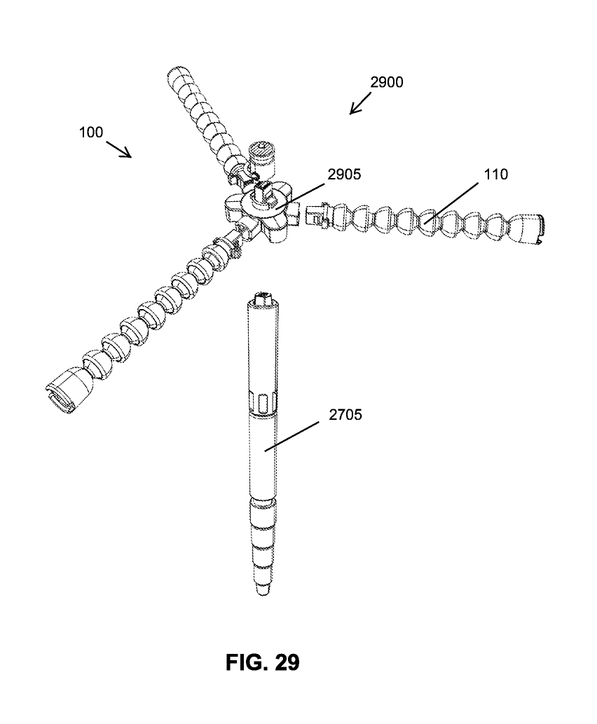

FIG. 29 illustrates a top perspective view of a second monopod mounting system 2900 including a basic monopod 2705 and multipoint reconfigurable system 100 shown in FIG. 4 with a modified multipoint attachment body 2905 as compared to multipoint attachment body 105. Mounting system 2900 provides flexlegs 110 coupled to multipoint attachment body 2905 as structural support for stabilizing mounting system 2900 or coupled to terminators for engagement with accessories necessary/useful for any particular task at hand. A modification to multipoint attachment body 2905 is made to illustrate that attachment points are not necessarily constrained to selection from a single universal connector system. The proximal attachment point on monopod 2705 includes a type 1 coupler from the quick connect twist connector system. A complementary mating type 2 coupler located at one of the underside attachment points (preferably at the center underside attachment point) is modified from the previously illustrated female quick connect snap connector from the quick connect snap connector system. The modification includes making the type 2 coupler compatible or replacing it with a coupler from the same connector system as monopod 2705.

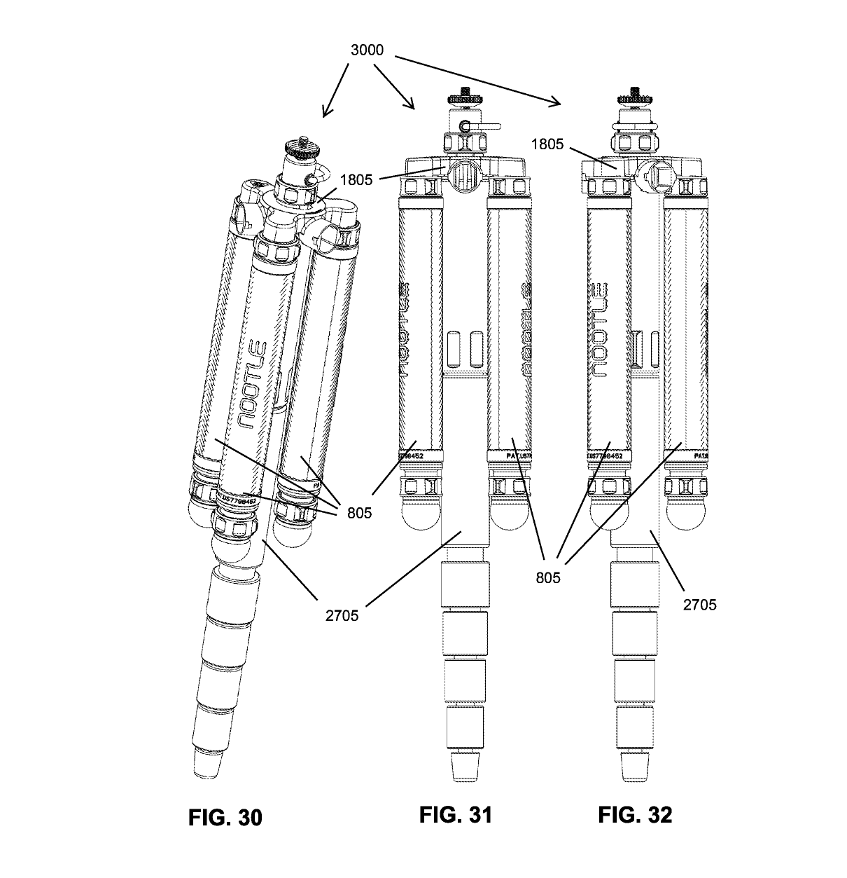

FIG. 30 illustrates a top perspective view of a third monopod mounting system 3000 including a basic monopod 2705 and a multipoint attachment body 1805 and further including a plurality of flexpods 805 coupled to multipoint attachment body 1805. FIG. 31 illustrates a front plan view of system 3000 and FIG. 32 illustrates a side plan view of system 3000. Flexpods 805 are shown with magnetic terminators coupled to distal attachment points as further described herein. One or more flexpods 805 may be operated as shown, or detached and coupled to lateral attachment points of multipoint attachment body 1805 which could generally reproduce one or more functions of second monopod mounting system 2900.

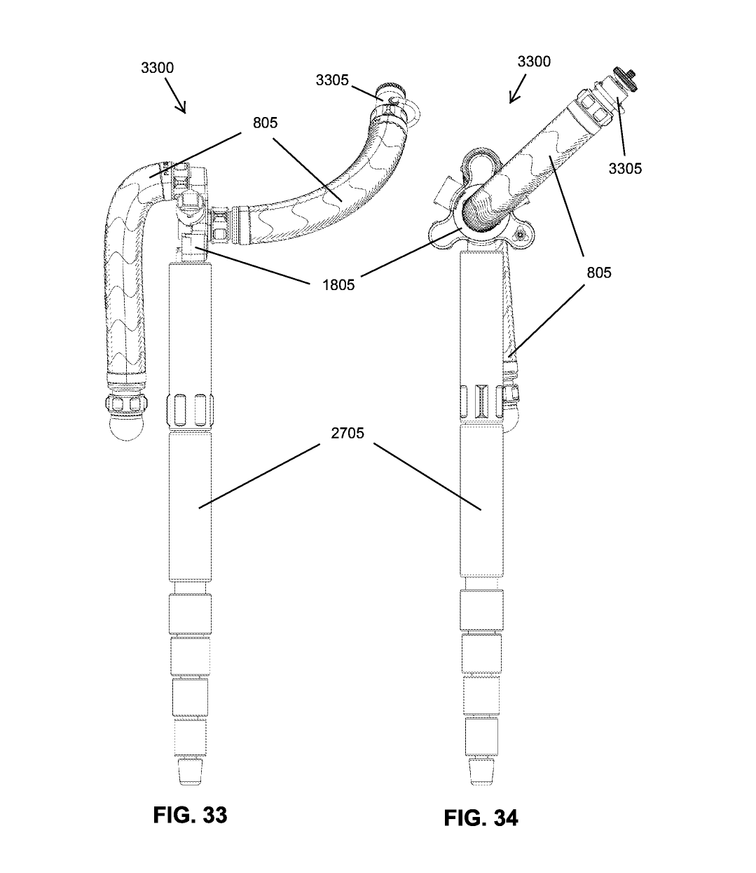

FIG. 33 illustrates a side plan view of a monopod mounting system 3300 including a basic monopod 2705 and a multipoint attachment body 1805, and further including a plurality of flexpods 805, and FIG. 34 illustrates a front plan view of system 3300. System 3300 illustrates that the proximal attachment point of monopod 2705 may be coupled to a lateral attachment point of multipoint attachment body 1805. System 3300, like system 3000 for example, includes a modified object coupler 3305 that is similar to object coupler 115. A difference between modified object coupler 3305 and object coupler 115 is that the type 2 coupler in each is chosen from a different universal connector system. Modified object coupler 3305 uses a type 2 coupler from the quick connect twist connector system while object coupler 115 uses a type 2 coupler from the quick connect snap connector system, but are otherwise interchangeable in terms of function and operation. Further details and operation of these object couplers are described herein. Modified object coupler 3305 in FIG. 33 and FIG. 34 is shown decoupled from direct attachment to the topside attachment point of multipoint attachment body 1805 (as seen in FIG. 30 for example) with flexpod 805 inserted therebetween.

A pair of flexpods 805 are illustrated in FIG. 33 and FIG. 34, one of which is used in refinements in positioning/pointing any object coupled to modified object coupler 3305 and supported by system 3300. The other flexpod 805 is available for stabilization or accessory support for example.

Tripod-Flexleg Combination

Disclosed is a combination of a set of tripod legs, and one or more optional flexlegs, coupled to a multipoint attachment body producing a tripod mounting system. Preferably the tripod legs include a telescoping straight, rigid member having an attachment point (e.g., a type 1 coupler) including a rotatable oblique pivoting member disposed at a proximal end for engaging an attachment point (e.g., a type 2 coupler) on the underside and/or lateral surfaces of the multipoint attachment body (either the three non-centered underside attachment points or the three lateral attachment points). Each tripod leg includes an attachment point at each distal end that supports any desired (but optional) connector (e.g., a type 1 coupler since the attachment point at the proximal end supports a type 2 coupler).

The flexlegs may be used to help maintain a desired orientation for the tripod system (e.g., lashing to a third object), help hold equipment in a desired position (e.g., equipment and/or equipment adapters with attachment points having connectors from, or compatible with, the universal connector system employed by the multipoint attachment body, for example, type 1 couplers compatible with the several type 2 couplers arranged on the preferred embodiments of the multipoint attachment bodies), or a combination thereof.

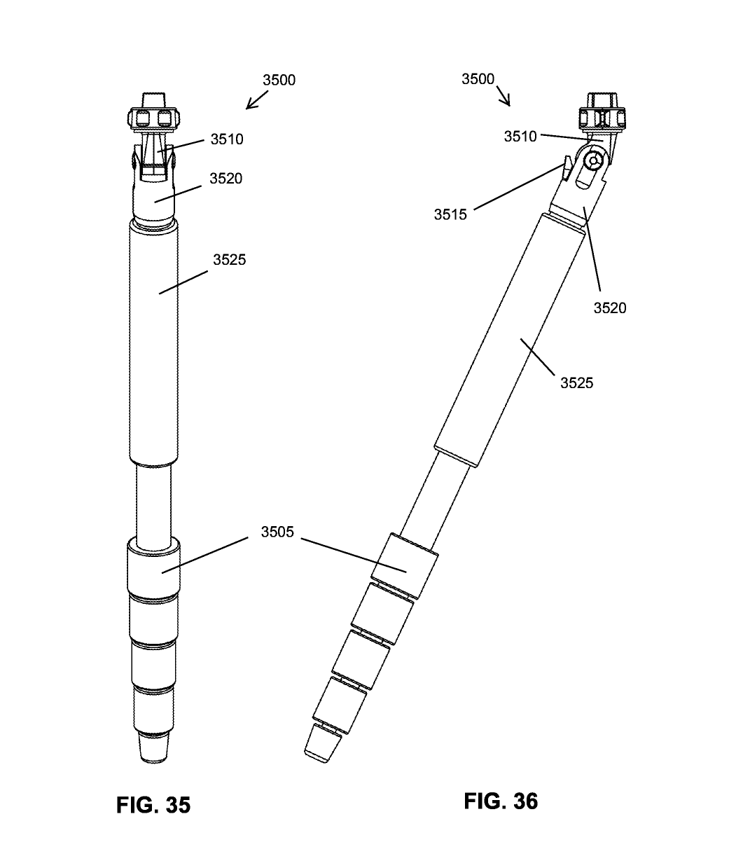

FIG. 35 illustrates a rear plan view of a tripod leg 3500, including a telescoping body 3505 pivotally coupled to an oblique attachment member 3510. FIG. 36 illustrates a side plan view of tripod leg 3500. Attachment member 3510 is disposed at an angle (e.g., less than 45 degrees) relative to a coupling axis of a proximal attachment point that supports a type 1 coupler. (Typically this type 1 coupler engages a complementary type 2 coupler on an underside or lateral surface, hence this coupling axis is typically vertical or horizontal, respectively.)

Telescoping body 3505 is rotatably coupled to attachment member 3510, preferably with a locking variable angle coupling, that is released by a lock release tab 3515. In the preferred embodiment, the rotation coupling is a “ratchet” type coupling in which relative rotation is “free” in one direction and restricted in the opposing direction. Actuation of lock release tab 3515 permits non-restricted rotation in either direction. Similarly to monopod 2705, telescoping of telescoping body 3505 is controlled by a relative twisting between a first part 3520 and a second part 3525 of telescoping body 3505. Relative rotation of first part 3520 and second part 3525 in a first direction locks the amount of telescoping action of telescoping body 3505 and relative rotation in a second direction unlocks the amount of telescoping action.

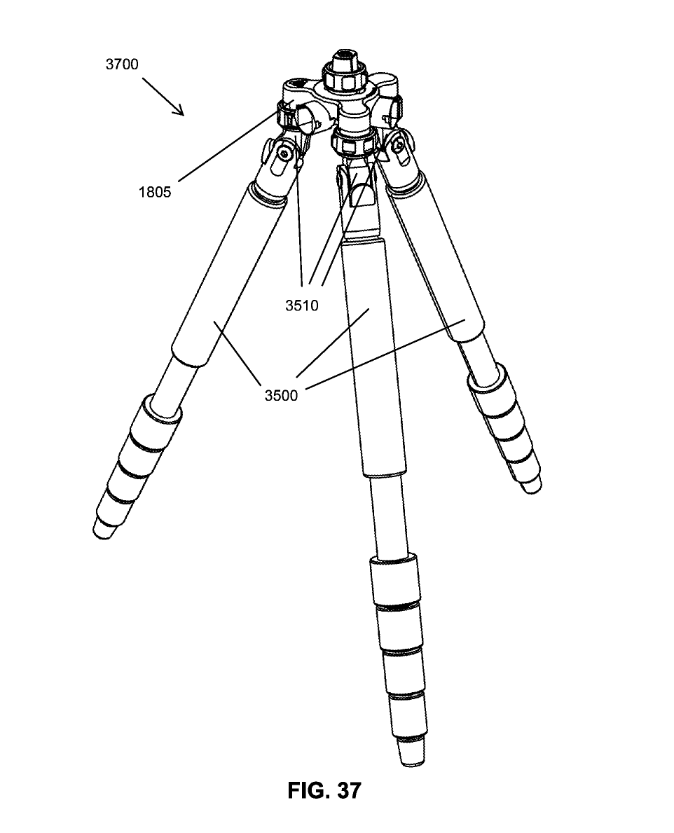

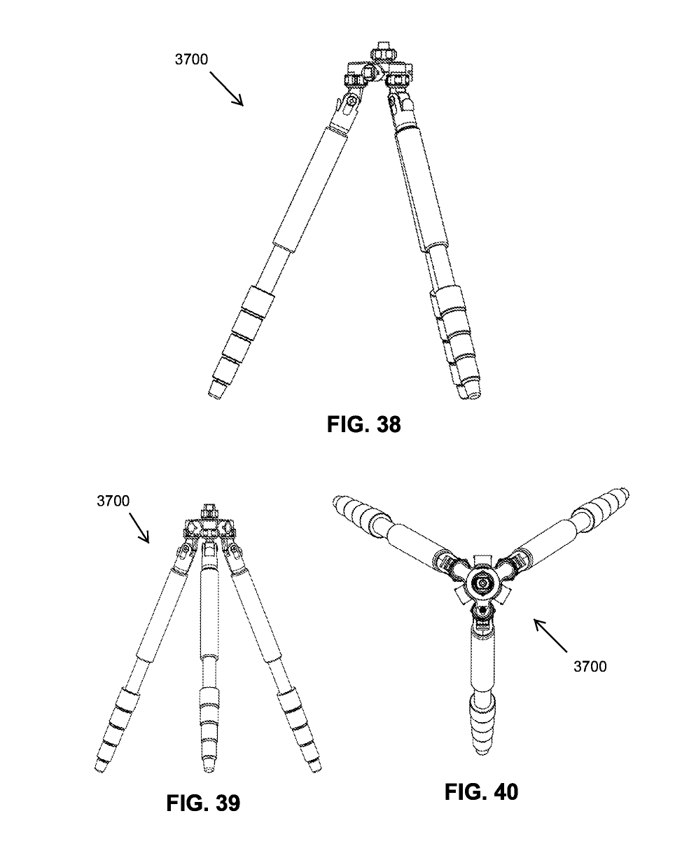

FIG. 37 illustrates a top perspective view of a first tripod mounting system 3700 including three tripod legs 3500 and a multipoint attachment body 1805. FIG. 38 illustrates a side plan view of tripod mounting system 3700; FIG. 39 illustrates a front plan view of tripod mounting system 3700; and FIG. 40 illustrates a top plan view of tripod mounting system 3700.

Tripod mounting system 3700 couples three tripod legs 3500 at three non-centered underside attachment points to multipoint attachment body 1805. As further described herein, the preferred type 1 couplers have two rotational modes (that is, the preferred type 1 couplers may engage any of the preferred compatible type 2 couplers with a first orientation or in a second orientation that is 180 degrees different.) This provides additional advantages for tripod leg 3500 when coupling to multipoint attachment body 1805 in that oblique attachment member 3510 is supported in two distinct directions (e.g., an angle away from a center vertical axis of multipoint attachment body 1805 or an angle towards the center vertical axis), each direction corresponding to the different orientation of the coupler engagement).

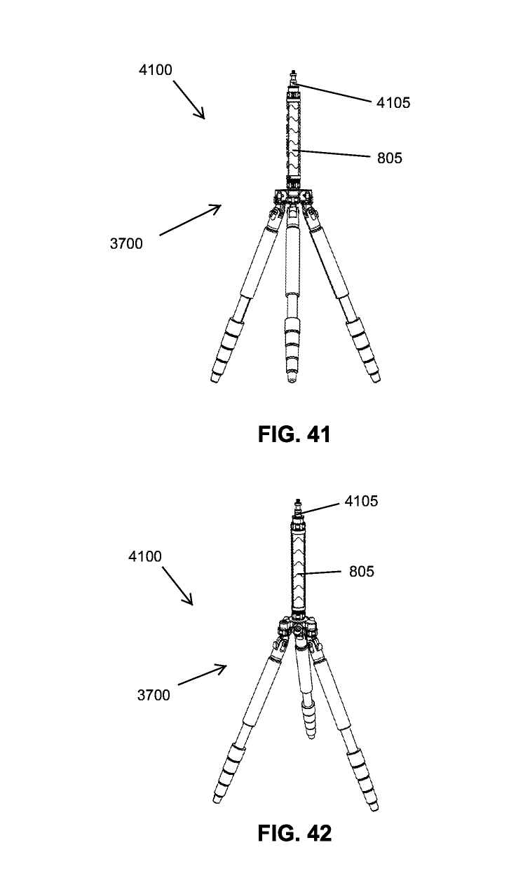

FIG. 41 illustrates a front view of a second tripod mounting system 4100 including first tripod mounting system 3700 modified by addition of flexpod 805 and a lightmount coupler 4105. FIG. 42 illustrates a rear plan view of second tripod mounting system 4100. First tripod mounting system 3700 did not include any particular attachment to the topside attachment point of multipoint attachment body 1805. Second tripod mounting system 4100 illustrates that flexpod 805 may be attached to the topside attachment point of multipoint attachment body 1805 and an adapter or coupler attached, in turn to a free end of flexpod 805. Lightmount coupler 4105 represents a possible type of terminator that may be employed, in addition to the object couplers (e.g., object coupler 115 and modified object coupler 3305 or the like) previously described or other terminators described elsewhere herein.

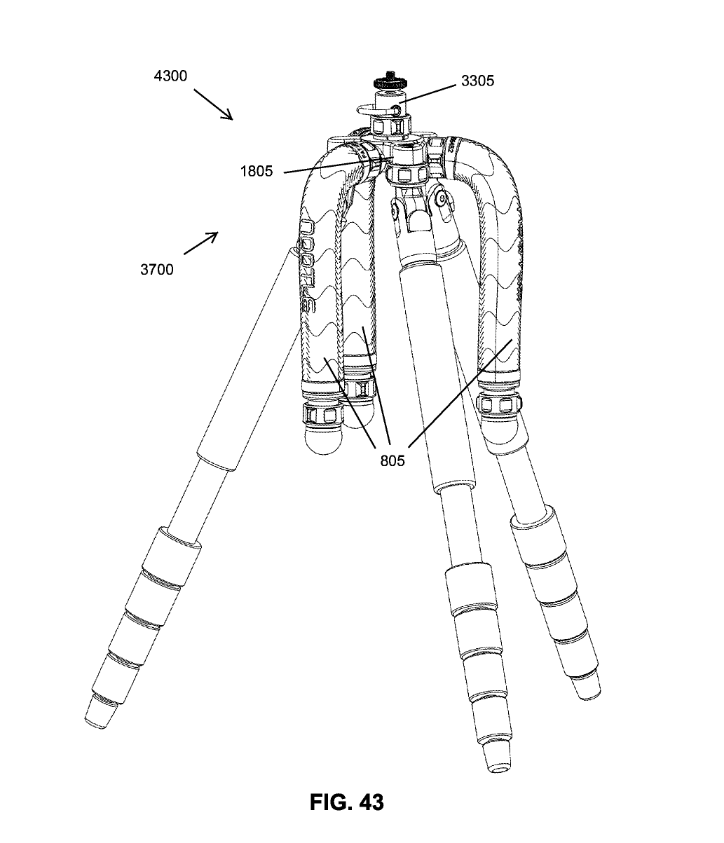

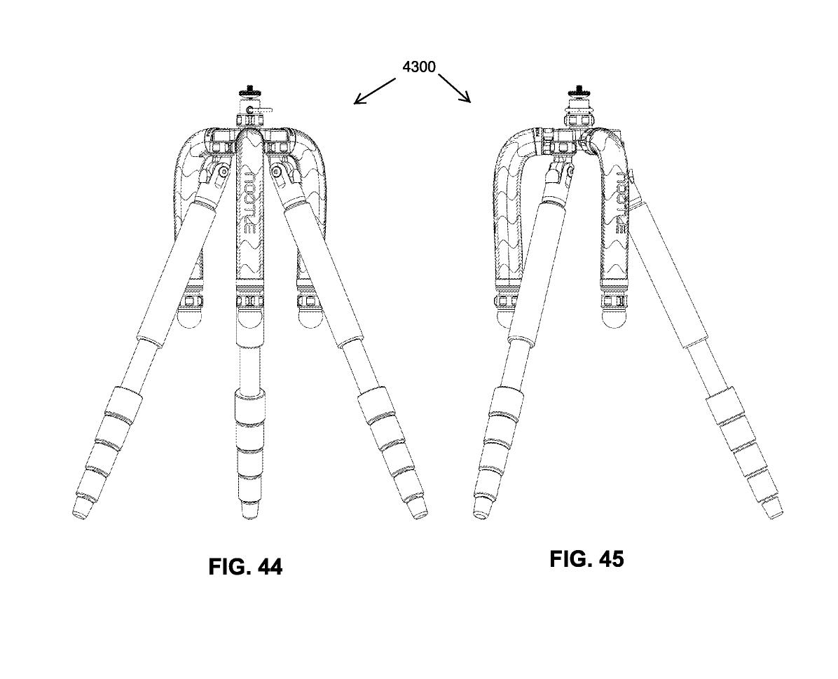

FIG. 43 illustrates a front view of a third tripod mounting system 4300 including first tripod mounting system 3700 modified by addition of three lateral flexpods 805 and modified object coupler 3305. FIG. 44 illustrates a rear plan view of third tripod mounting system 4300, and FIG. 45 illustrates a side plan view of third tripod mounting system 4300. Third tripod mounting system 4300 includes the components of first tripod mounting system 3700 and adds three flexpods 805 (fitted with representative terminators, e.g., magnetic terminator feet) to lateral attachment points of multipoint attachment body 1805. Additionally, modified object coupler 3305 is supported at the topside attachment point of multipoint attachment body 1805.

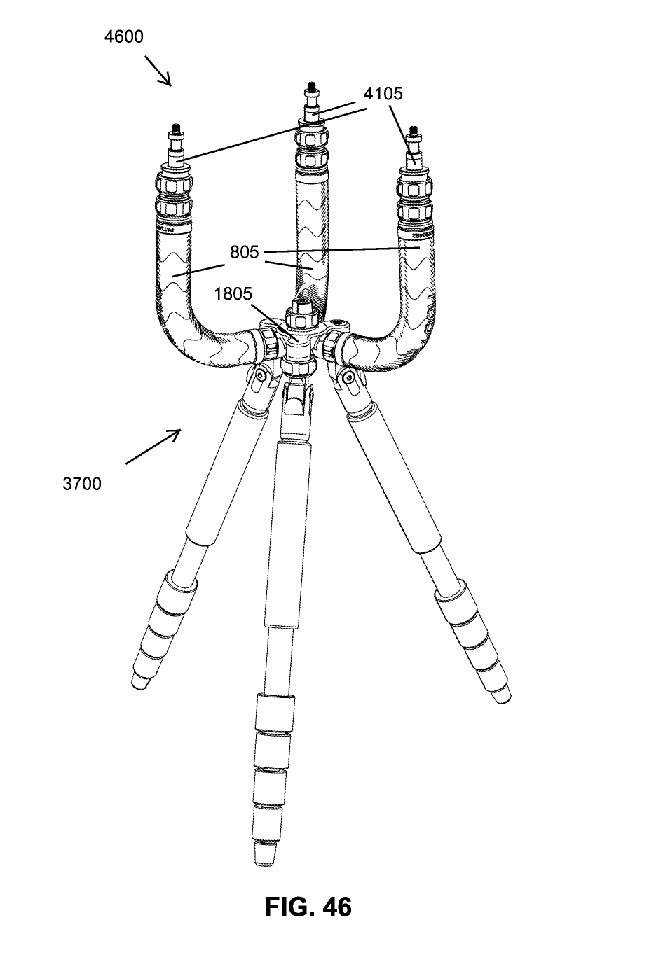

FIG. 46 illustrates a front perspective view of a fourth tripod mounting system 4600 including first tripod mounting system 3700 modified by addition of three lateral flexpods 805, each including lightmount coupler 4105. Similar to tripod mounting system 4300, three lateral flexpods 805 are coupled to multipoint attachment body 1805. In this configuration, flexpods 805 are terminated with lightmount coupler 4105 and the topmost attachment point of multipoint attachment body 1805 (with a type 1 coupler from the quick connect twist connector universal connector system) is uncommitted and available for a terminator, such as a modified object coupler for holding, positioning, and/or pointing an object.

Multi-Method Mounting System

Disclosed is a three-type multi-method mounting system for use in easily converting a mounted portable device from a desired “pod” mode to a carrying mode, particularly when used with the system and methods disclosed herein, including the multipoint attachment body, couplers from one or more compatible universal connector systems, and other compatible components and accessories. Multi-head mount is a specialized type of attachment point terminator as further discussed herein.

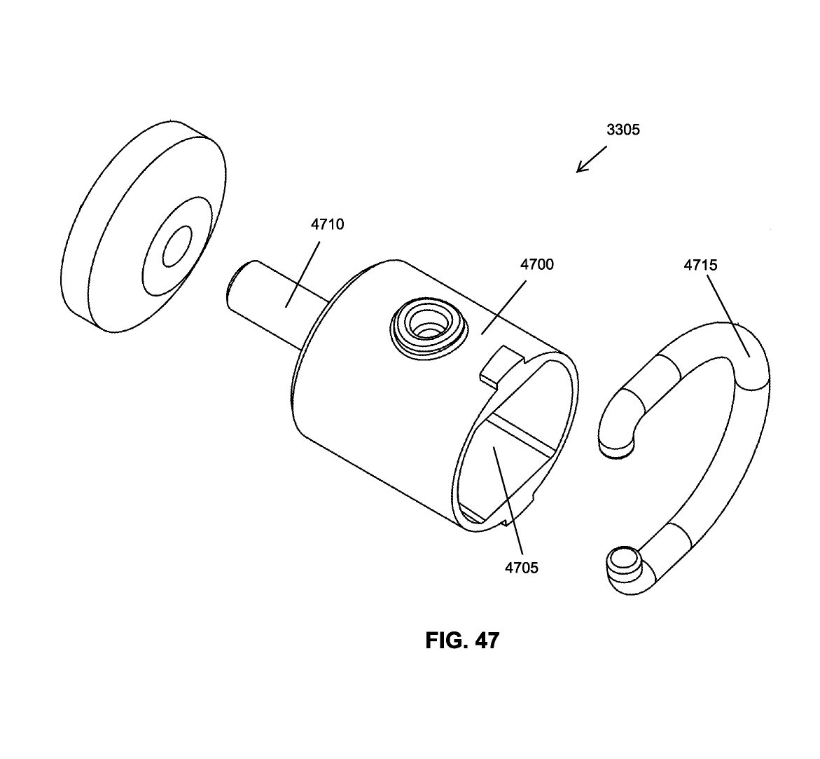

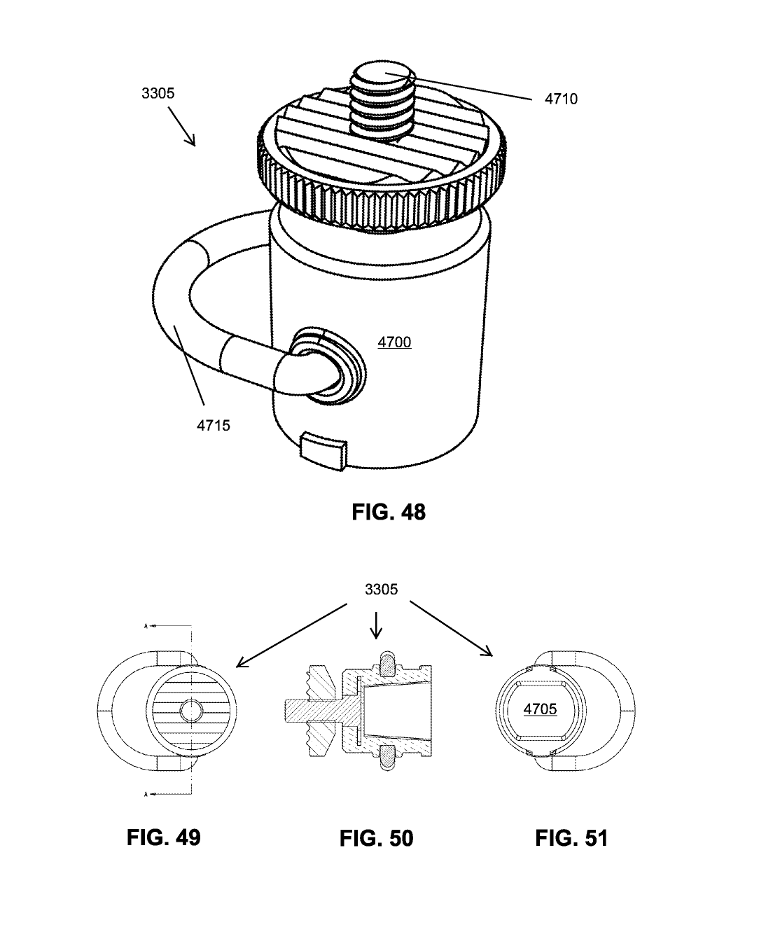

FIG. 47 illustrates an exploded perspective view of modified object coupler 3305, FIG. 48 illustrates a perspective view of modified object coupler 3305, FIG. 49 illustrates a top plan view of modified object coupler 3305, FIG. 50 illustrates a sectional view of modified object coupler 3305, and FIG. 51 illustrates a bottom plan view of modified object coupler 3305. Modified object coupler 3305 includes a housing 4700 having an attachment point 4705 configured with a type 2 coupler, for example with a type 2 quick connect twist connector as shown, though a type 2 quick connect snap connector may be used (see, for example, object coupler 115). On an opposing side of housing 4700 from attachment point 4705 is a connector 4710 appropriate for the object to be mounted using modified object coupler 3305. For example, as noted herein, many cameras include a standard ¼″ threaded socket and for objects including such a socket, connector 4710 includes a standard ¼″ 20 threaded bolt. Pivotally coupled to a midpoint of housing 4700 is a metal ring 4715. Metal ring 4715 is configured so that it may swing over and past attachment point 4705 whenever a connector is disengaged from attachment point 4705.

In operation for coupling to a desired object, connector 4710 engages the desired object and holds it firmly. A type 1 coupler compatible with the type 2 coupler provided at attachment point 4705, such as one on a flexpod 805, monopod 2705, or topside attachment point of a multipoint attachment body 1805, or the like, engages the type 2 coupler. The desired object is then engaged, through the attaching structure coupled to attachment point 4705, to a supporting, holding, positioning, and pointing system (e.g., tripod mounting system 4300). In the event that a user desires to carry the desired object without moving/carrying tripod mounting system 4300, the user simply disconnects the type 1 quick connect coupler from engagement with the type 2 coupler at attachment point 4705. (During this disconnection, in many cases it is possible to do so without disturbing the other structural elements of the supporting structure (tripod mounting system 4300 for example).)

Upon disconnection, metal ring 4715 becomes completely available for carrying use as it may freely rotate past attachment point 4705. Metal ring 4715 is available in many possible ways, such as by engaging a hook, clip, fastener (quick connect or otherwise) or the like to the pivoting metal ring 4715. The hook, clip, fastener or other device is preferably attached to a strap, lanyard, loop or other device that may be placed around the neck or wrist or shoulder or otherwise secured by the user. Since connector 4710 is firmly attached to the desired object, the desired object is firmly and securely held by the user when gripping the strap, lanyard, loop, or other device though its engagement with metal ring 4715.

When the user desires to reuse the supporting structure, the hook, clip, fastener, or other device is disengaged from metal ring 4715 and a type 1 coupler that is part of the supporting structure (or that will be coupled into the supporting structure) engages the type 2 coupler at attachment point 4705. In the preferred embodiment, the hook, clip, fastener, or other device is described as engaging with and disengaging from metal ring 4715 to use the coupler at attachment point 4705. In some embodiments, this may not be necessary as the hook, clip, fastener, or other device may remain affixed (in a non-interfering way) to metal ring 4715 as it swings into and out of position.

When the desired object is a camera, and the camera includes the standard ¼″ threaded socket on the underside of the camera housing, connector 4710 includes a standard ¼″ threaded bolt threaded into engagement with the threaded socket. The camera may be coupled onto tripod mounting system 3700 by attaching a type 1 coupler that is part of tripod mounting system 3700 (e.g., the type 1 coupler at the topside surface of multipoint attachment body 1805) to the type 2 coupler at attachment point 4705 (metal ring 4715 is rotated out of interference if necessary). When the user desires to carry the camera, the type 1 coupler is quickly disengaged and the camera is lifted free from tripod mounting system 3700. A snaphook, secured to a loop, is snapped onto metal ring 4715. The user places the loop over her head and around her neck and is then free to let go of the camera. The camera then hangs (in this example upside down) from the loop. The user may freely operate the camera as normal. When desiring to reattach the camera to tripod mounting system 3700, the user simply unsnaps the snaphook, swings metal ring 4715 out of interference, and a type 1 coupler re-engages the type 2 coupler that is located at attachment point 4705.

Modified object coupler 3305 is a multi-method mounting system for several reasons including the availability of the threaded connector, the quick connect universal connector, and the rotating metal ring, offering many different coupling solutions to the user.

Attachment Point Terminators

Disclosed are a set of attachment point terminators that are used to enhance functionality by coupling to a connector at one of the many attachment points available when using the systems and methods of preferred embodiments of the present invention. Using connectors from the universal connector system enables a user to supplement and extend the inherent functionality of the system and method. In some cases, the attachment point terminators are feet (e.g., posts, spikes, balls, suction pads, magnetic structures and the like), and in others they are adapters, couplers, and the like, that may also function as feet or the like. Not all the structures require one or more of these largely optional, but useful, attachment point terminators, particularly as some of these are most useful in specific contexts.

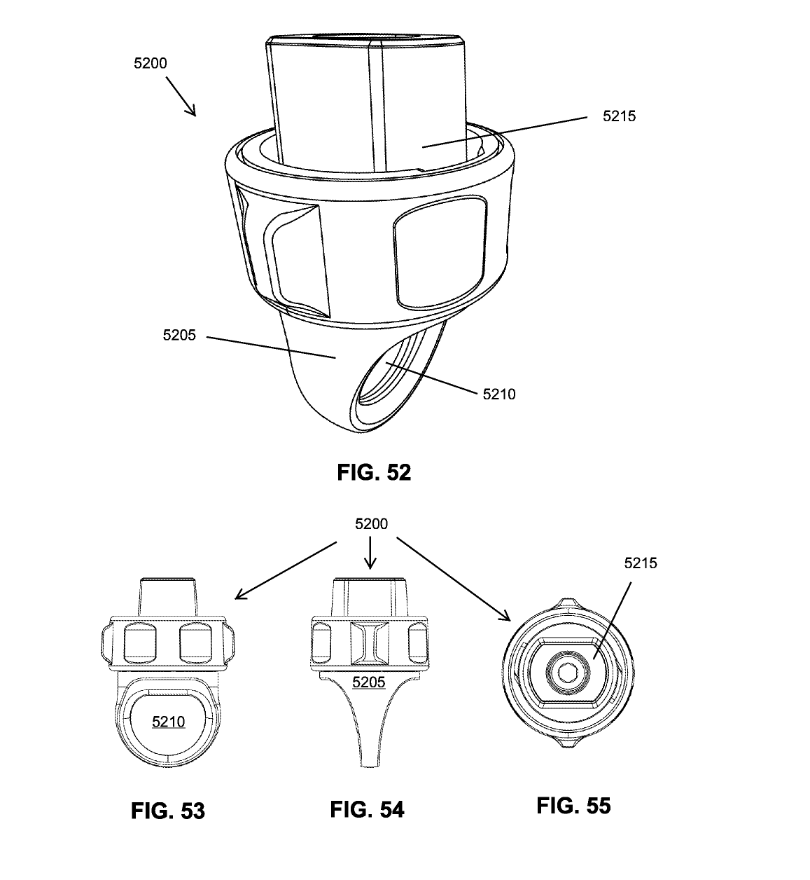

FIG. 52 illustrates a perspective view of a lanyard terminator assembly 5200, FIG. 53 illustrates a front plan view of lanyard terminator assembly 5200, FIG. 54 illustrates a side plan view of lanyard terminator assembly 5200, and FIG. 55 illustrates a top plan view of lanyard terminator assembly 5200. Lanyard terminator assembly 5200 includes a body 5205 defining a closed lanyard ring 5210 with an opposing attachment point 5215 provided in this case with a type 1 quick connect twist connector.

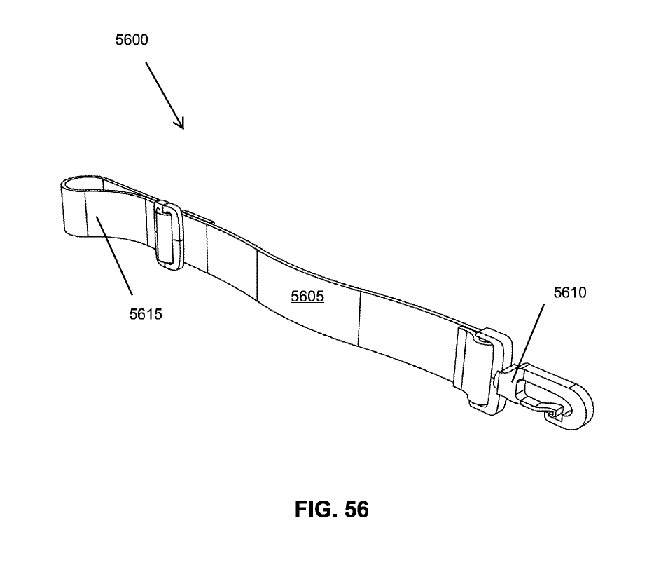

FIG. 56 is a perspective view of a representative strap 5600 for use with the multipoint reconfigurable systems and structures described herein. Strap 5600 includes a flexible, non-stretching, sturdy member 5605 with a quick connect snaphook 5610 at a proximal end and a carrying loop 5615 at a distal end opposite of the proximal end. Snaphook 5610 is particularly suited to coupling to metal ring 4715 or lanyard ring 5210, with carrying loop 5615 allowing the user to easily carry an object.

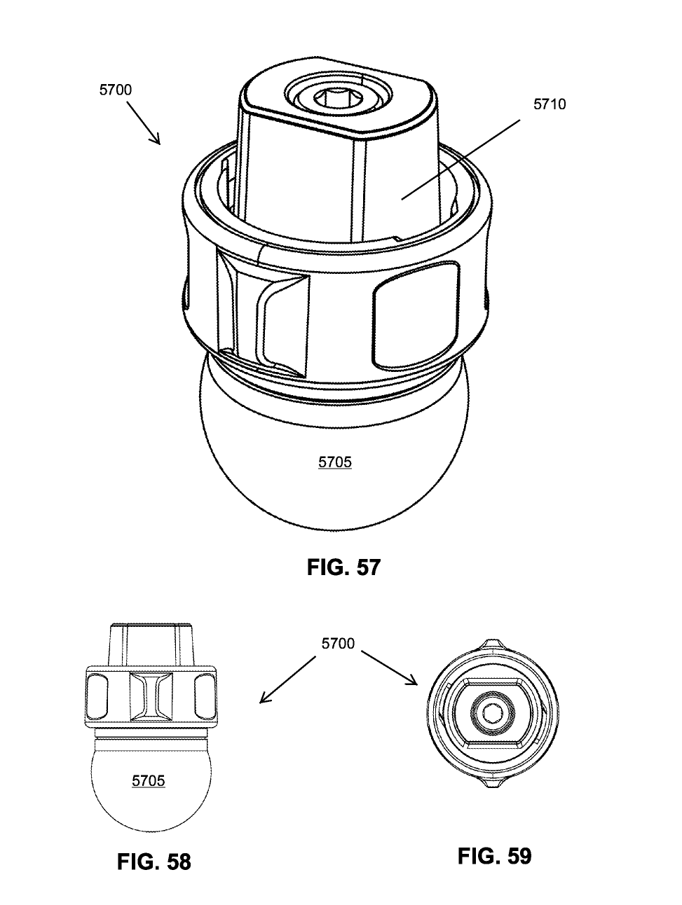

FIG. 57 illustrates a perspective view of a magnetic terminator assembly 5700, FIG. 58 illustrates a front plan view of magnetic terminator assembly 5700, and FIG. 59 illustrates a top plan view of magnetic terminator assembly 5700. Magnetic terminator assembly 5700 includes a body 5705 enclosing a magnet (not shown) with an opposing attachment point 5710 provided in this case with a type 1 quick connect twist connector. Body 5705 may be hard or soft and functions, in the absence of magnetic material, a standard termination foot.

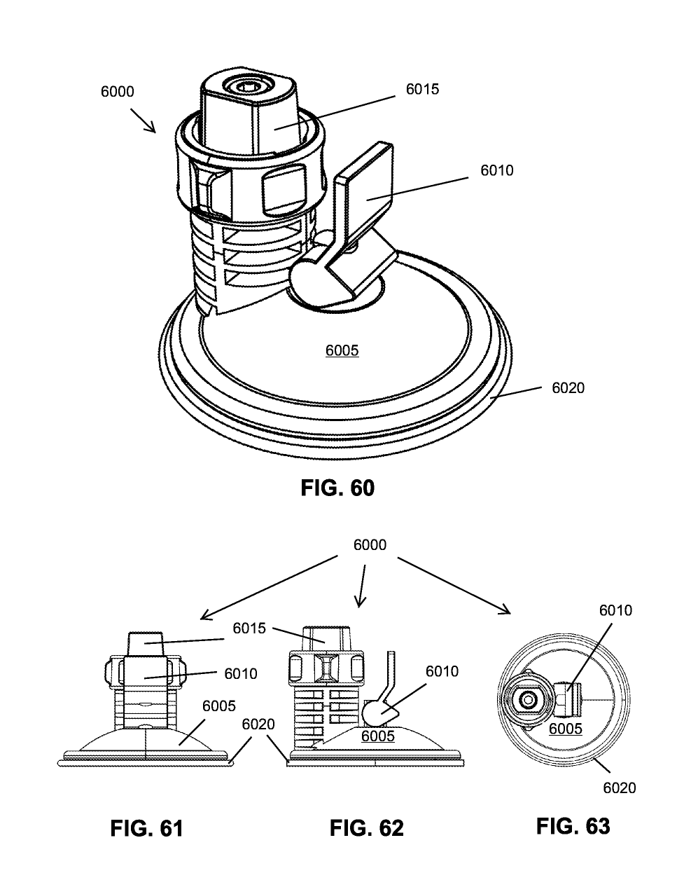

FIG. 60 illustrates a perspective view of a suction-foot terminator assembly 6000, FIG. 61 illustrates a front plan view of suction-foot terminator assembly 6000, FIG. 62 illustrates a side plan view of the suction-foot terminator assembly 6000, and FIG. 63 illustrates a top plan view of suction-foot terminator assembly 6000. Suction-foot terminator assembly 6000 includes a body 6005 including a suction-control level 6010 that produces and releases a vacuum-creating volume between a surface and body 6005 in conventional fashion. Body 6005 includes an opposing attachment point 6015 provided in this case with a type 1 quick connect twist connector. Body 6005 includes a viscoelastic polymer (e.g., rubber) ring 6020 for contact with a surface to form an air-tight seal to aid in production and retention of a pressure-differential.

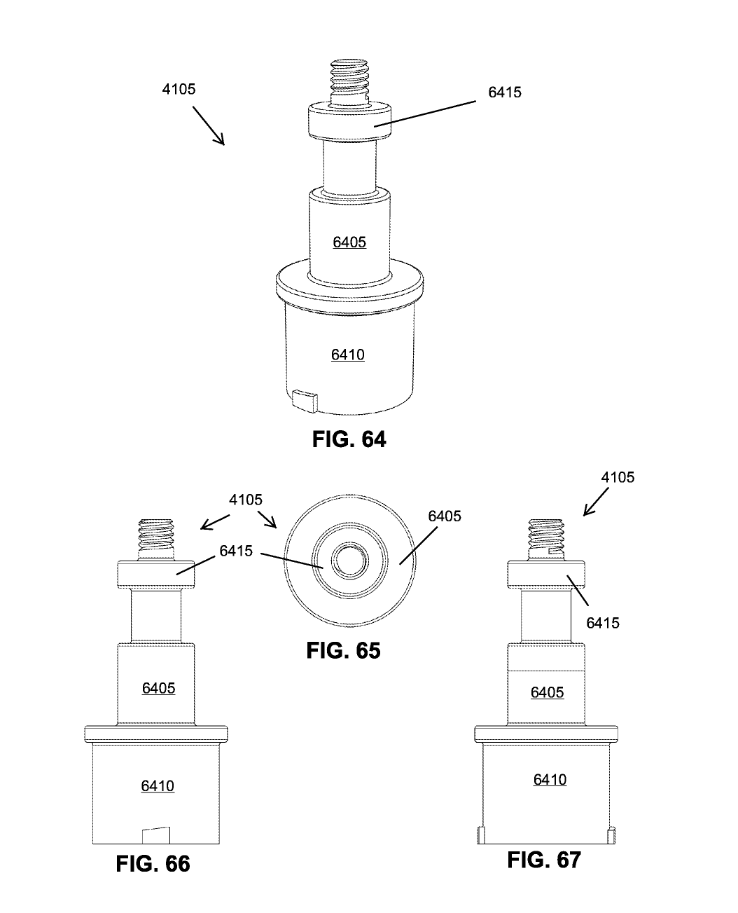

FIG. 64 illustrates a perspective view of the lightmount coupler 4105 introduced in FIG. 41, FIG. 65 illustrates a top plan view of lightmount coupler 4105, FIG. 66 illustrates a front plan view of lightmount coupler 4105, and FIG. 67 illustrates a side plan view of lightmount coupler 4105. Lightmount coupler 4105 includes a body 6405 that has an attachment point 6410 at one end (supporting, for example, a type 2 coupler from a quick connect twist connector universal connector system) and a connector 6415 for engaging a light socket, such as a standard threaded bolt for engaging a standard threaded socket.

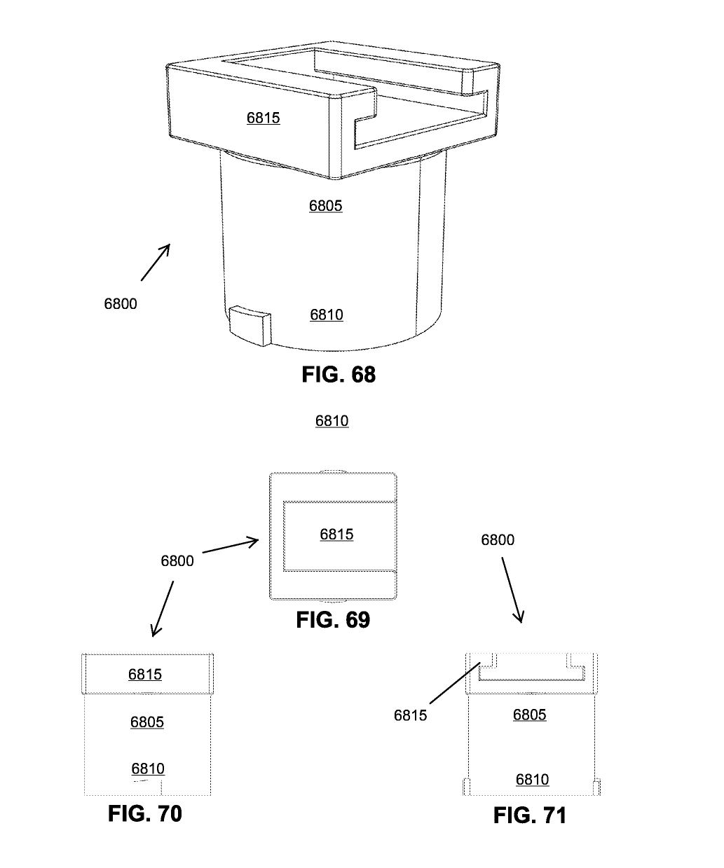

FIG. 68 illustrates a perspective view of a magnetic mount coupler 8000, FIG. 69 illustrates a top plan view of magnetic mount coupler 8000, FIG. 70 illustrates a front plan view of magnetic mount coupler 8000, and FIG. 71 illustrates a side plan view of magnetic mount coupler 8000. Magnetic mount coupler 8000 includes a body 6805 that has an attachment point 6810 at one end (supporting, for example, a type 2 coupler from a quick connect twist connector universal connector system) and a connector 6815 for engaging a flash, such as a standard fixed shoe mount for engaging a standard flash shoe.

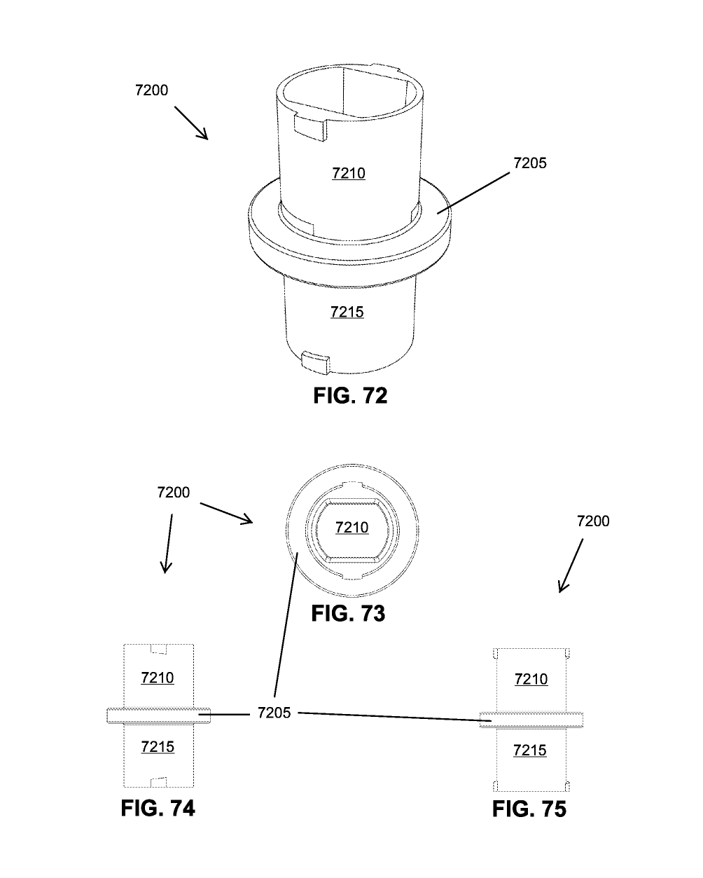

FIG. 72 illustrates a perspective view of a type 2 to type 2 coupler 7200, FIG. 73 illustrates a top plan view of type 2 to type 2 coupler 7200, FIG. 74 illustrates a front plan view of type 2 to type 2 coupler 7200, and FIG. 75 illustrates a side plan view of type 2 to type 2 coupler 7200. Type 2 to type 2 coupler 7200 includes a body 7205 supporting a first attachment point 7210 at a proximal end and a second attachment point 7215 at a distal end. In the preferred embodiment, both attachment points support, for example, a type 2 coupler from a quick connect twist connector universal connector system. In the preferred embodiment, both type 2 couplers are from the same universal connector system, however in some embodiments, the type 2 couplers are from compatible universal connector systems, while in other embodiments, the type 2 couplers are from distinct, and possibly incompatible, universal connector systems.

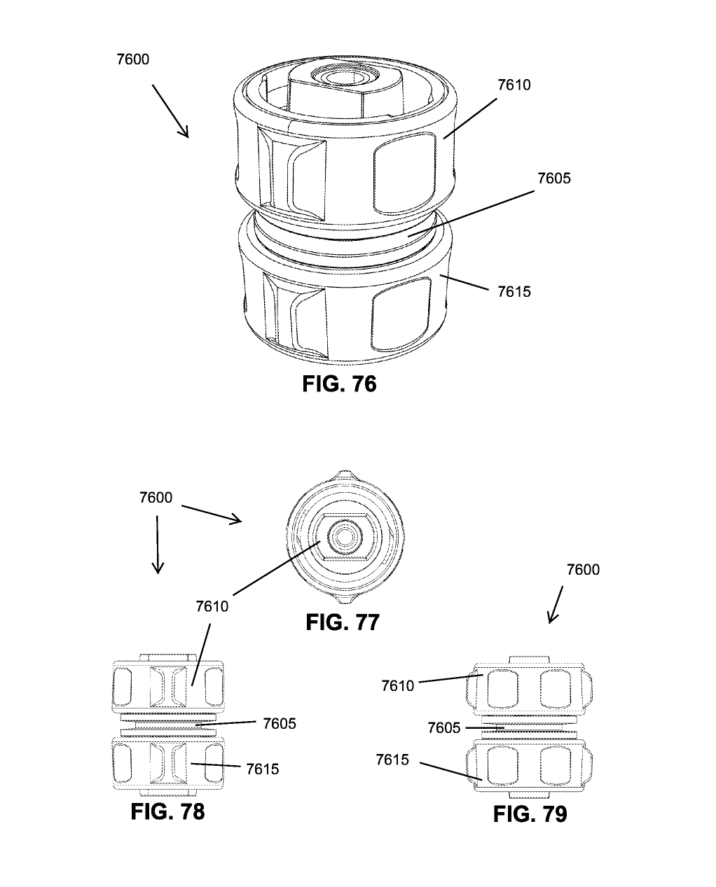

FIG. 76 illustrates a perspective view of a type 1 to type 1 coupler 7600, FIG. 77 illustrates a top plan view of type 1 to type 1 coupler 7600, FIG. 78 illustrates a front plan view of type 1 to type 1 coupler 7600, and FIG. 79 illustrates a side plan view of the type 1 to type 1 coupler 7600. Type 1 to type 1 coupler 7600 includes a body 7605 supporting a first attachment point 7610 at a proximal end and a second attachment point 7615 at a distal end. In the preferred embodiment, both attachment points support, for example, a type 1 coupler from a quick connect twist connector universal connector system. In the preferred embodiment, both type 1 couplers are from the same universal connector system, however in some embodiments, the type 1 couplers are from compatible universal connector systems, while in other embodiments, the type 1 couplers are from distinct, and possibly incompatible, universal connector systems.

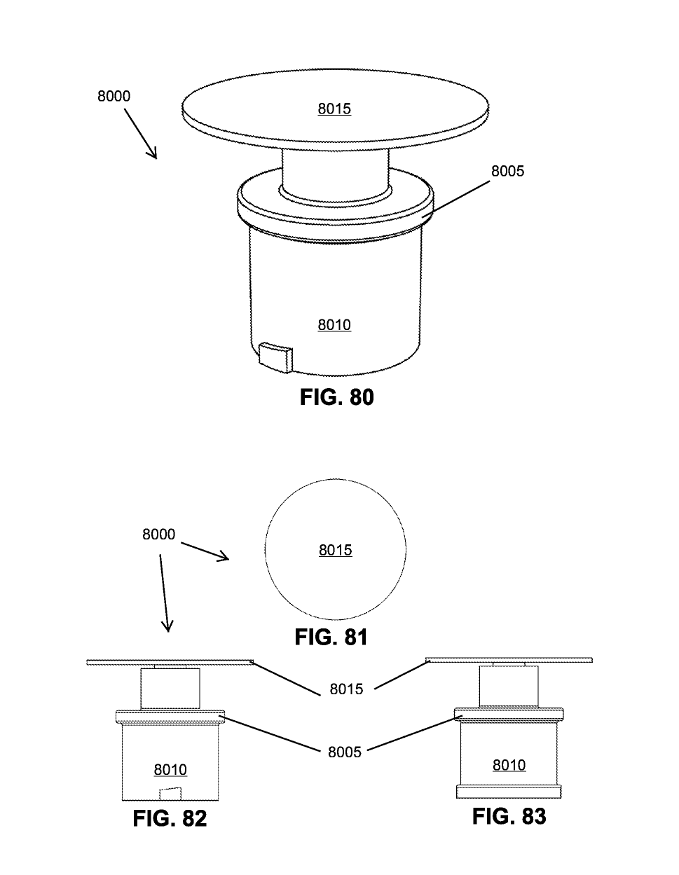

FIG. 80 illustrates a perspective view of a magnetic mount coupler 8000, FIG. 81 illustrates a top plan view of magnetic mount coupler 8000, FIG. 82 illustrates a front plan view of magnetic mount coupler 8000, and FIG. 83 illustrates a side plan view of magnetic mount coupler 8000. Magnetic mount coupler 8000 includes a body 8005 that has an attachment point 8010 at one end (supporting, for example, a type 2 coupler from a quick connect twist connector universal connector system) and a magnetic element 6015 (for example, a plate, disk, cube, rod, or the like) for quick reconfigurable attachment placement to metal surfaces.

Universal Connector Systems

Disclosed herein are two specific universal connector systems that are useable at the various attachment points described herein, including body attachment points, leg (flexible, straight, or combination) attachment points, terminator attachment points, and adapter/mount attachment points. A universal connector system used at these attachment points provides an enhanced multipoint mount experience. The universal connector systems include a quick connect snap system and a quick connect twist system. Unless the context suggests otherwise, the various universal connector systems are considered interchangeable (though not necessarily always inter-matable) with respect to the attachment points described herein.

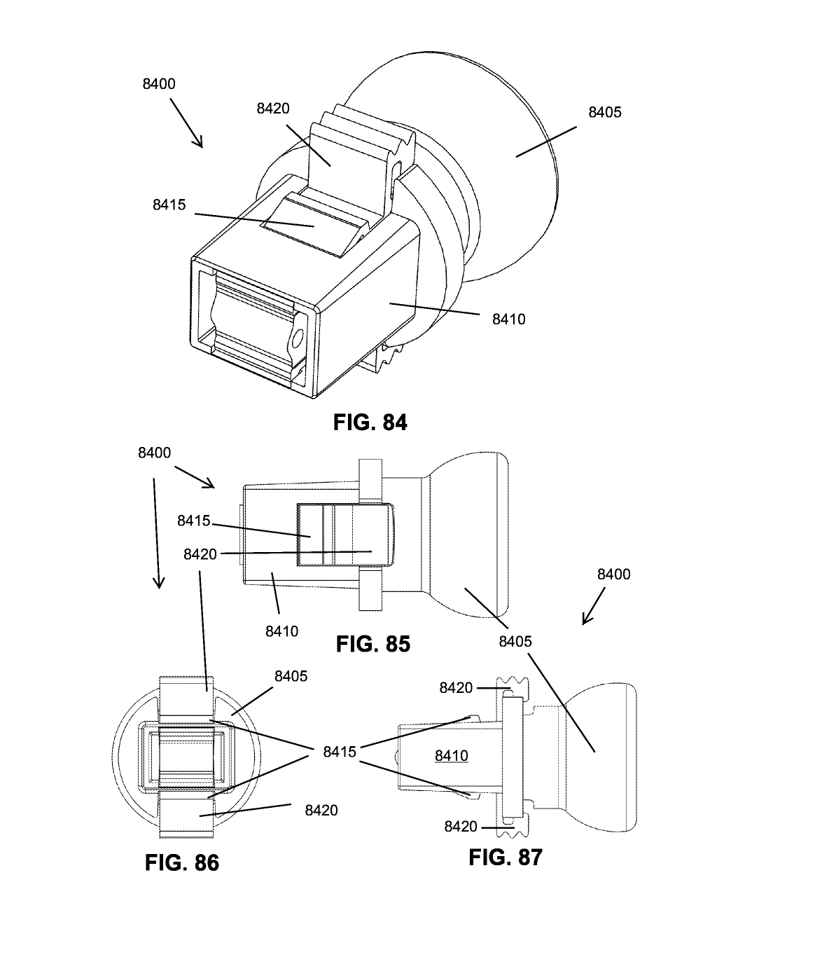

FIG. 84 illustrates a front perspective view of a type 1 coupler 8400 from a quick connect snap universal connector system, FIG. 85 illustrates a top plan view of type 1 coupler 8400, FIG. 86 illustrates a front plan view of type 1 coupler 8400, and FIG. 87 illustrates a side plan view of type 1 coupler 8400. Type 1 coupler 8400 includes a body 8405 supporting a connector housing 8410 that defines a rectilinear frustum perimeter having four tapering sidewalls that narrow towards an end away from body 8405. As noted herein, for example the discussion of FIG. 12, type 1 coupler 8400 includes a pair of latching springs that each provide a locking tab 8415 and a connector release tab 8420. Ramped faces of locking tabs 8415 allow type 1 coupler to be inserted without operation of connector release tabs 8420 as locking tabs 8415 “snap” into place once type 1 coupler 8400 is inserted sufficiently within the mating type 2 coupler.

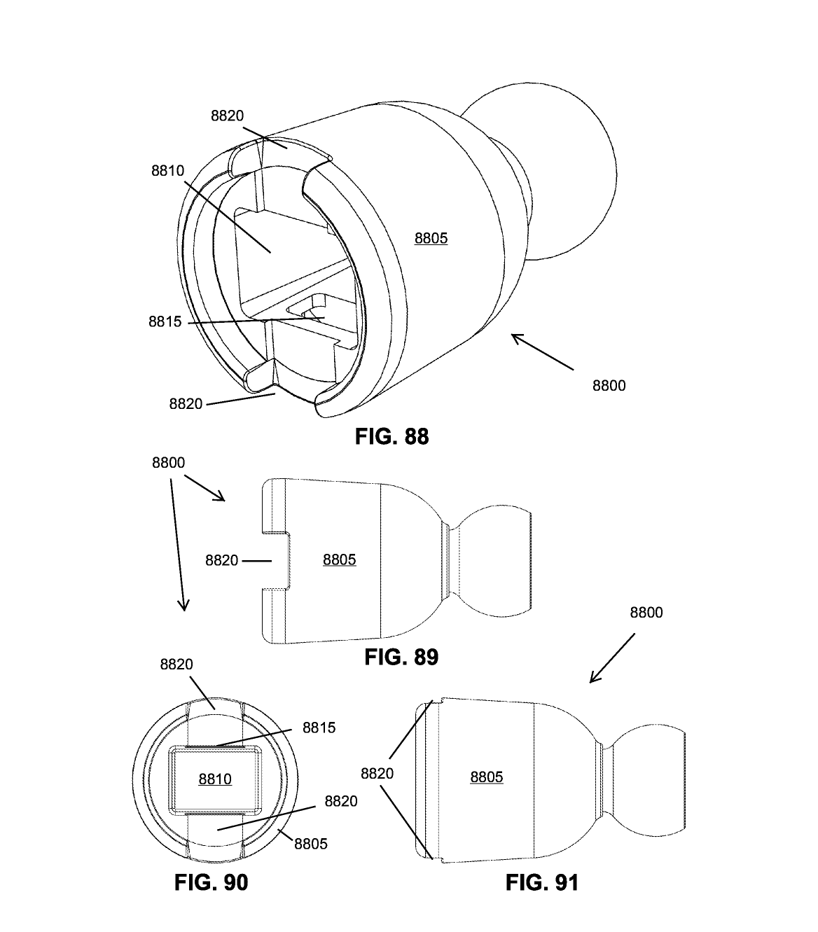

FIG. 88 illustrates a front perspective view of a type 2 coupler 8800 from the quick connect snap universal connector system, FIG. 89 illustrates a top plan view of type 2 coupler 8800, FIG. 90 illustrates a front plan view of type 2 coupler 8800, and FIG. 91 illustrates a side plan view of type 2 coupler 8800. Type 2 coupler 8800 includes a body 8805 defining a connector cavity 8810 that defines a rectilinear frustum perimeter having four tapering sidewalls that narrow at an end towards body 8805 (i.e., deeper into connector cavity 8810) which is complementary to housing 8410 of type 1 coupler 8400.

Body 8805 of type 2 coupler 8800 further defines a pair of lateral internal body recesses 8815 and a pair of lateral external sidewall recesses 8820. Locking tabs 8415 engage internal body recesses 8815 and connector release tabs 8420 fit within external sidewall recesses 8820. Ramped faces of locking tabs 8415 operate against the perimeter of connector cavity 8810 to compress the supporting latching springs.

In operation, insertion of type 1 coupler 8400 into type 2 coupler 8800, causes the ramped faces to compress the latching springs until both locking tabs 8415 engage internal body recesses 8815. Type 1 coupler 8400 remains secured to type 2 coupler 8800 until the user actuates both connector release tabs 8420 through external sidewall recesses 8820 which retracts locking tabs 8415 from internal body recesses 8815 and enables type 1 coupler 8400 to be disengaged from type 2 coupler 8800.

The tapering walls of coupler 8400 and coupler 8800 reduce connector sloppiness by increasing a mating surface area while more easily permitting disengagement without binding during retraction of type 1 coupler 8400 from type 2 coupler 8800.

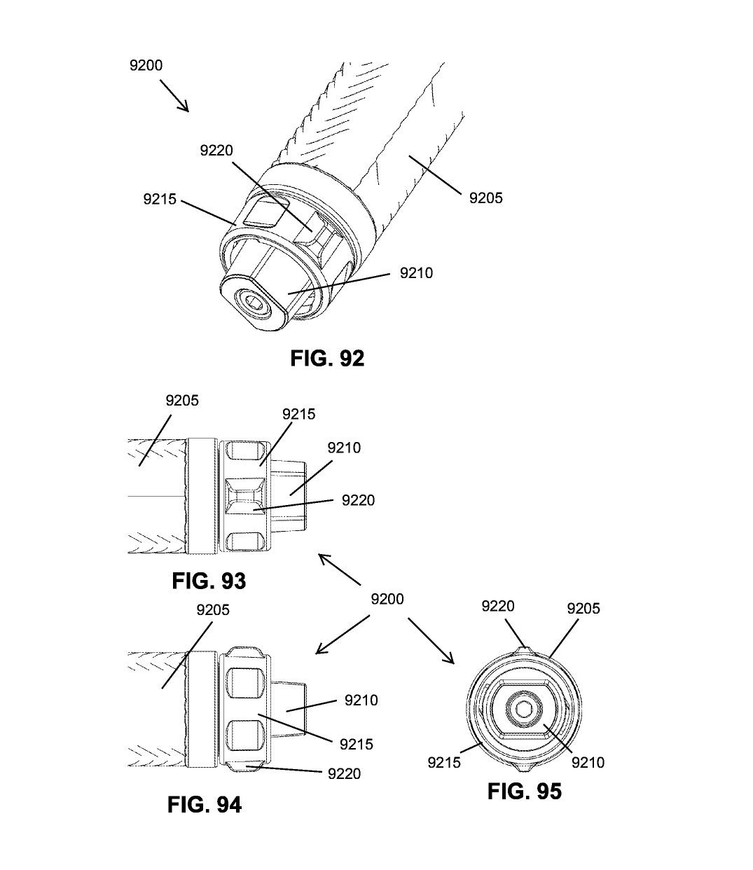

FIG. 92 illustrates a front perspective view of a type 1 coupler 9200 from a quick connect twist universal connector system, FIG. 93 illustrates a top plan view of type 1 coupler 9200, FIG. 94 illustrates a side plan view of type 1 coupler 9200, and FIG. 95 illustrates a front plan view of type 1 coupler 9200. Type 1 coupler 9200 includes a body 9205 supporting a connector housing 9210 that defines a rectilinear frustum perimeter having four tapering sidewalls that narrow towards an end away from body 9205. Rather than using locking tabs as used in type 1 coupler 8400, type 1 coupler 9200 includes a rotating ring assembly 9215 that provides a pair of helical channels on an inside surface that control engagement of the twist connectors by interaction with complementary locking flanges used with quick connect twist type 2 couplers. Ring assembly 9215 rotates in one direction to engage and rotates in an opposite direction to disengage as more fully explained below. Ring assembly 9215 includes an outer gnurled surface 9220 to aid in twisting in either direction.

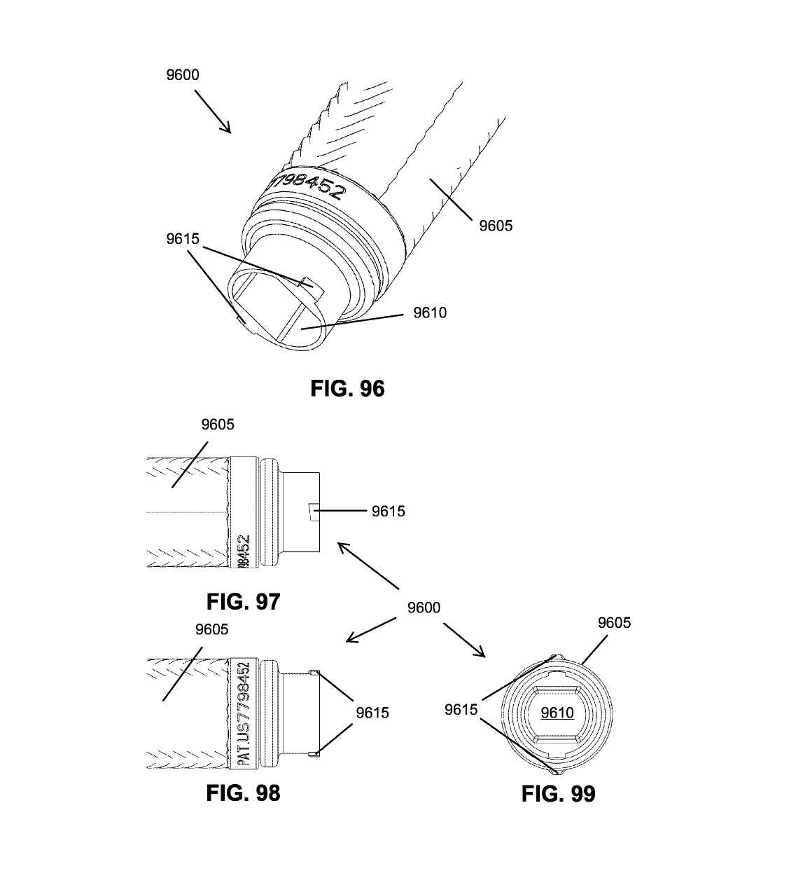

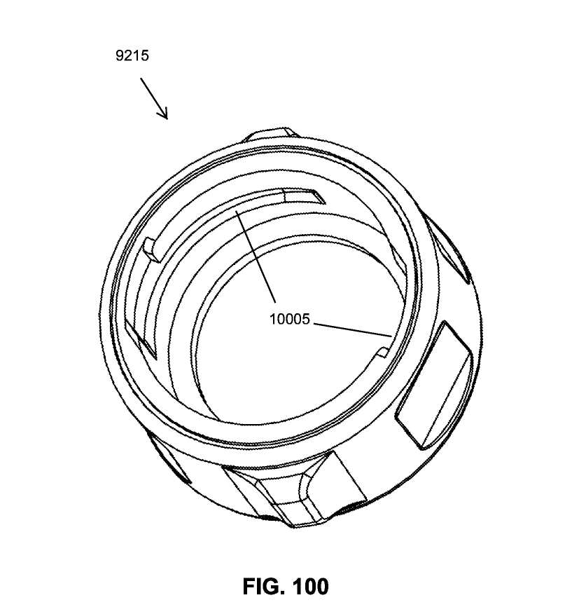

FIG. 96 illustrates a front perspective view of a type 2 coupler 9600 from the quick connect twist universal connector system, FIG. 97 illustrates a top plan view of type 2 9600, FIG. 98 illustrates a side plan view of type 2 coupler 9600, and FIG. 99 illustrates a front plan view of type 2 coupler 9600. Type 2 coupler 9600 includes a body 9605 defining a connector cavity 9610 that defines a rectilinear frustum perimeter having four tapering sidewalls that narrow at an end towards body 9605 (i.e., deeper into connector cavity 9610) which is complementary to housing 9210 of type 1 coupler 9200.

Body 9605 of type 2 coupler 9600 further defines a pair of lateral external latching flanges 9615. Latching flanges 9615 are complementary to the helical channels formed in ring assembly 9215 and respond to rotation of ring assembly 9215 in one direction to engage the couplers and respond to rotation of ring assembly 9215 in the opposing direction to disengage the couplers. As more fully described below, the helical channels include detents which provide a type of “safety” to aid against accidental\unintended disengagement.

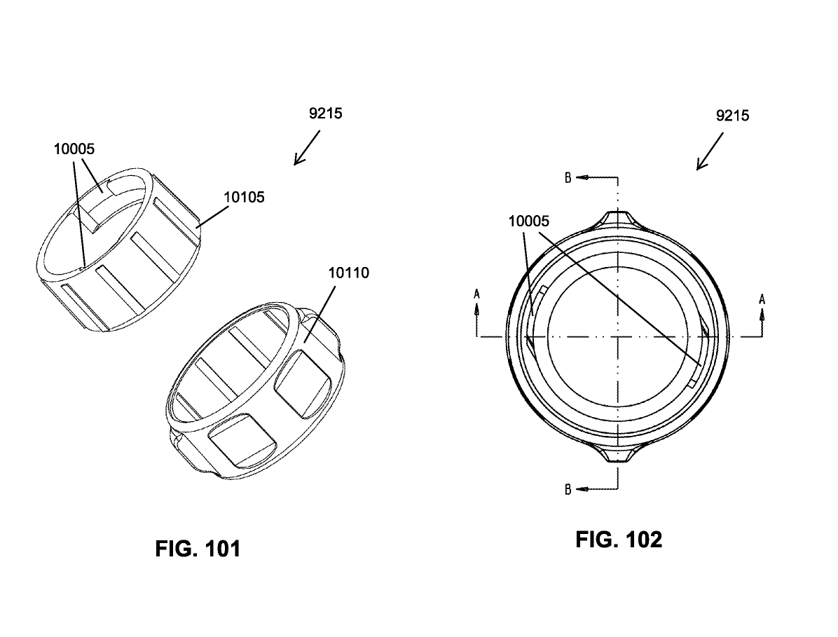

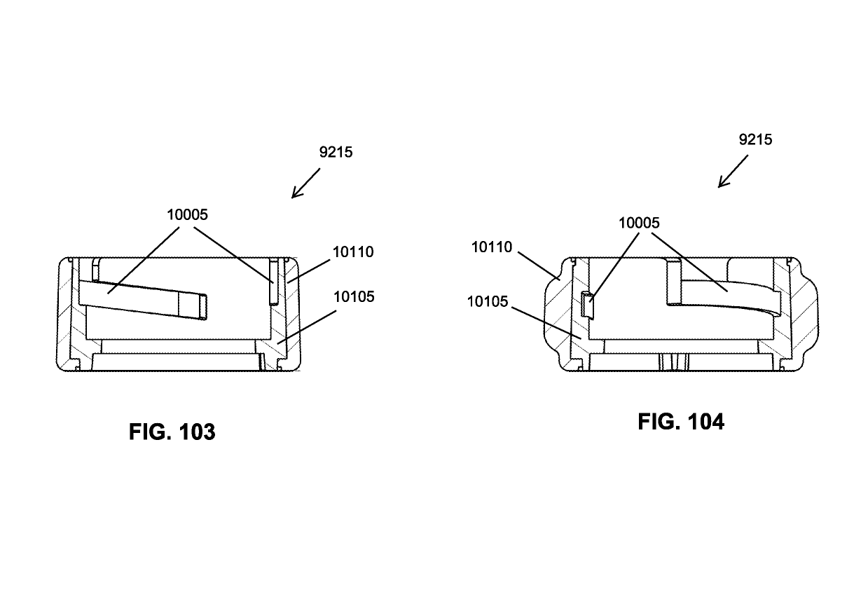

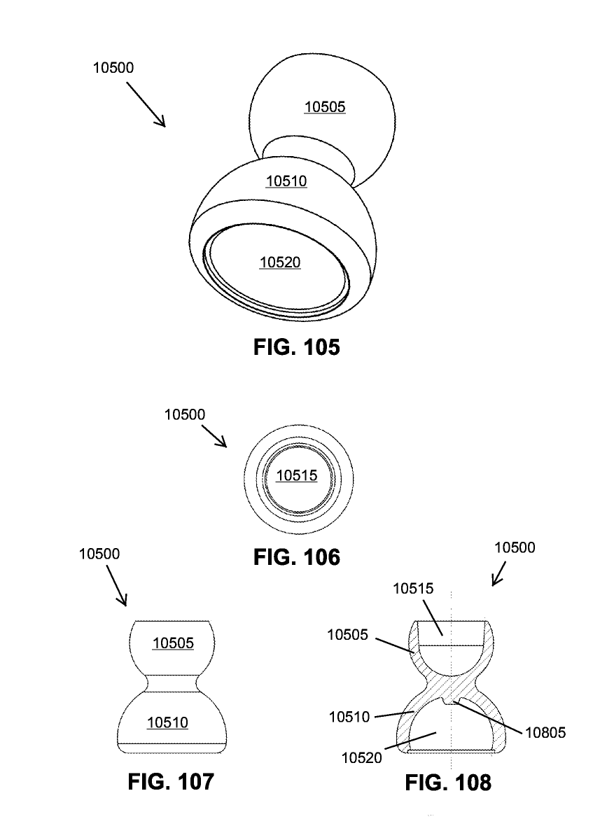

FIG. 100 illustrates a perspective view of rotating ring assembly 9215 shown in FIG. 92. Rotating ring assembly 9215 includes a pair of helical channels 10005. FIG. 101 illustrates a perspective exploded view of rotating ring assembly 9215 formed of an inner ring 10105 nested within an outer ring 10110. FIG. 102 illustrates a front plan view of rotating ring assembly 9215 highlighting a first section view A and a second section view B. FIG. 103 illustrates a first sectional view of rotating ring assembly 9215 using the first section view A and FIG. 104 illustrates a second sectional view of rotating ring assembly 9215 using the second section view B.

Type 1 Coupler 9200: Type 1 coupler 9200 includes a tapered and keyed set of interface surfaces and a locking mechanism to hold the assembly to the mating type 2 coupler. The locking mechanism is a 30 degree twisting bayonet with locking detents at the open and closed positions. The twist part of type 1 coupler 9200 (i.e., outer ring 10110) is preferably covered with a soft material to facilitate grip—though the soft touch material is optional.

Type 2 Coupler 9600: Type 2 coupler 9600 is a receptacle with corresponding tapered and keyed surfaces. There are also features (i.e., locking flanges 9615) to engage the locking mechanism of type 1 coupler 9200.

Type 1 coupler 9200 is inserted into the receptacle of type 2 coupler 9600. The twist-lock is then turned 30 degrees and snapped into position. The twisting mates the tapered and keyed surfaces. The ramp on the bayonet drives the couplers together and creates pressure on the tapered surfaces. The taper creates a snug fit that eliminates wobble between the couplers. The keyed surfaces (also tapered) provide anti rotation of the connectors.

To remove type 1 coupler 9200, twist the mechanism in the opposite direction 30 degrees until it snaps in place. The ramps of the bayonet are used in reverse to back the coupler out of position, eliminating the need to use a significant amount of force to remove it. This is important as embodiments not utilizing such a “backing out” mechanism have an increased chance to stick and then require some additional manipulation to successfully disengage.

The detent is a dual annular snap that is more prominent in the locked/connected position than in the open/un-connected position. The purpose for the detent at the open position is to a) keep the mechanism properly aligned for connecting and b) provide a tactile and audible signal to the user that the coupler is ready to be removed. The purpose of the detent at the closed position is to a) provide audible and tactile feedback that the coupler is locked in position and b) to provide an additional level of locking when fully connected - the snap must be overcome to unlock the coupler. This reduces unwanted releases of the couplers. Providing increased security in these connectors increases confidence of users, particularly users of high-priced equipment, that the quick connect connectors will not prematurely release and damage their equipment.

FIG. 105 illustrates a perspective view of a flexleg element 10500, FIG. 106 illustrates a front plan view of flexleg element 10500, FIG. 107 illustrates a side plan view of flexleg element 10500, and FIG. 108 illustrates a sectional view of flexleg element 10500. Flexleg element 10500 includes a type 1 body 10505 axially aligned with a type 2 body 10510. Type 1 body 10505 includes a cavity 10515 designed to reduce cost while preserving an outer profile. Type 2 body 10510 includes a cavity 10520 designed to receive type 1 body for a flexible connection. Cavity 10520 includes an axial stop 10805 that engages a lip of cavity 10515 to set a maximum flexing angle between flexleg elements 10500. A plurality of chained flexleg elements 10500 (type 1 bodies engaged within cavities 10520) produces a substantial part of flexleg 110. As seen in FIG. 84, body 8405 includes a type 2 body with a cavity 10520. As seen in FIG. 88, body 8805 includes a type 1 body. Thus the chained flexleg elements are terminated with a type 1 coupler (e.g., type 1 coupler 8400) including a type 2 body at one end and terminated with a type 2 coupler (e.g., type 2 coupler 8800) including a type 1 body at an opposite end. This is one possible way to form flexleg 110.

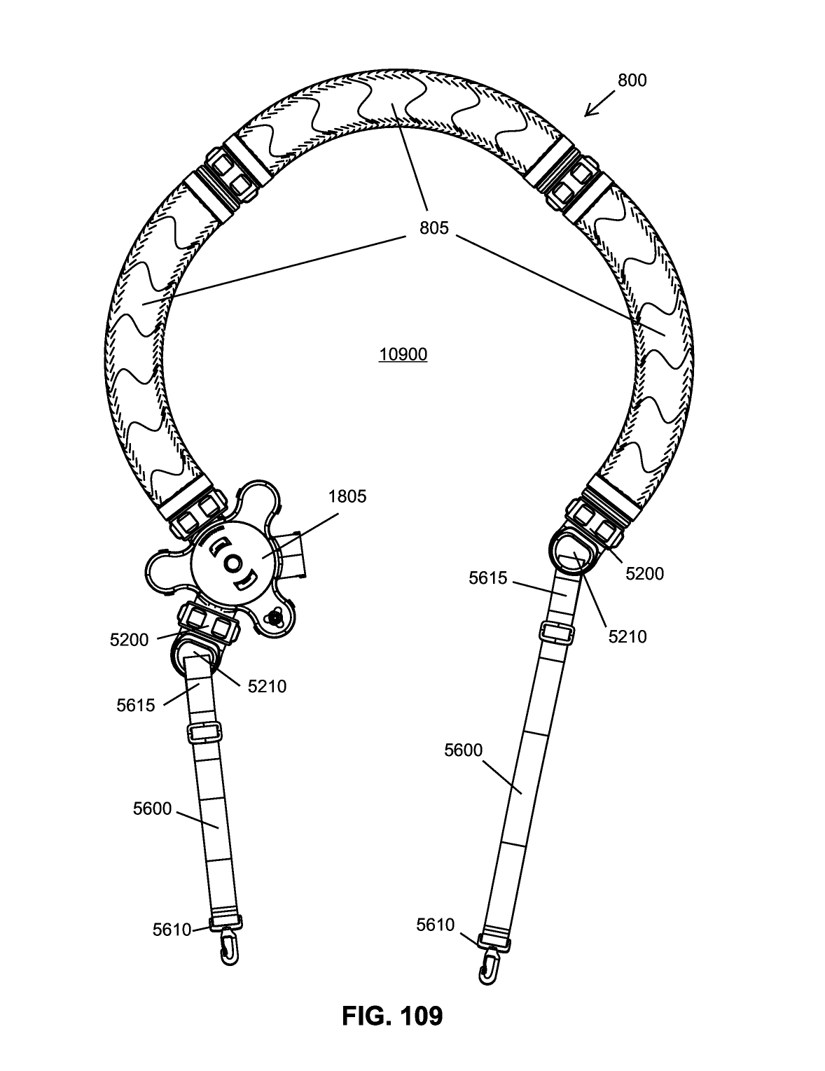

FIG. 109 illustrates a plan view of a tripod system 10900 reconfigured to carry an object around a neck of a user. Tripod system 10900 includes multipoint attachment body 1805, three flexpods 805, a pair of lanyard terminator assemblies 5200 and a pair of straps 5600. In one tripod mode, each flexpod 805 is coupled to one underside attachment point of multipoint attachment body 1805 and some object is supported by one or more of the other attachment points. A conventional tripod can be a challenge to pack up and carry in between uses, and generally serves no other use except when in the tripod mode. It is possible to reconfigure the tripod system for another use, such as a neckstrap for the object.

Flexpods 805 are detached from multipoint attachment body 1805 and serially coupled together to provide extended flexpod assembly 800 having a pair of ends. One end of extended flexpod assembly 800 is coupled to a lateral attachment point of multipoint attachment body 1805 while one lanyard terminator assembly 5200 is coupled to the other end of extended flexpod assembly 800. A second lanyard terminator assembly 5200 is coupled to a second lateral attachment point of multipoint attachment body 1805. Loop 5615 of a first strap 5600 is attached to lanyard ring 5210 of one lanyard terminator assembly 5200 and loop 5615 of a second strap 5600 is attached to lanyard ring 5210 of the other lanyard terminator assembly 5200. In this way, snaphooks 5610 of straps 5600 are free to engage mounting rings of the object (such as lateral strap rings of a camera) and to use reconfigured tripod assembly 10900 as a neckstrap to safely and conveniently carry the object until the tripod mode (or some other reconfigurement) is necessary or desirable.

Reversible Monopod/Unipod

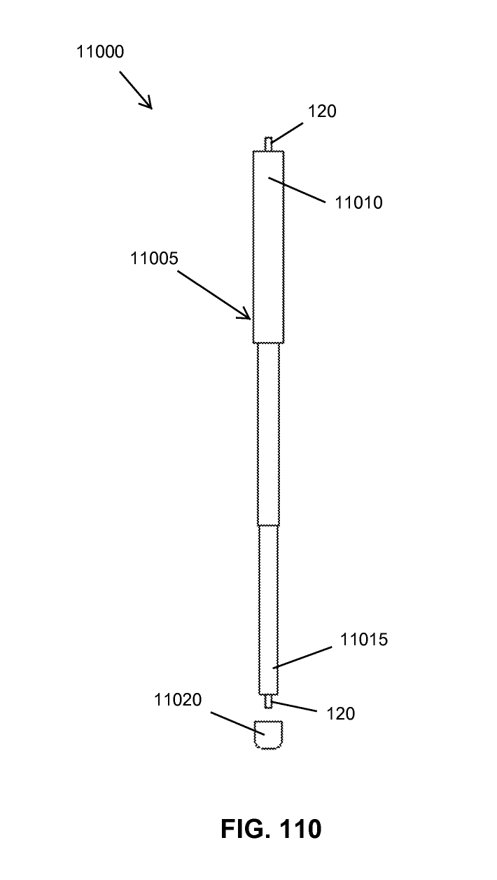

FIG. 110 illustrates a general schematic of a reversible monopod 11000. Reversible monopod 11000 includes a telescoping body 11005 with a pair of attachment points 120, a first attachment point 120 at a proximal end 11010 and a second attachment point 120 at a distal end 11015 of telescoping body 11005. Telescoping body 11005 includes a plurality of interconnected telescoping members, preferably the telescoping being lockable to set a magnitude of telescoping of the plurality of telescoping members to a desired extension/retraction. Use of a terminator 11020 (e.g., a rubber foot, suction foot, magnetic foot, spike, or the like) coupled to attachment point 120 at distal end 11015 enables reversible monopod 11000 to function as a standard monopod, particularly when an appropriate object coupler is coupled to attachment point 120 at proximal end 11010. As shown, single type 1 couplers (which can include standard ¼″-20 connectors and other quick connector couplers as described herein) are used at both attachment points 120, however this is but a representative embodiment. The type and distribution of coupler types varies by implementation and is not limiting to the present invention.

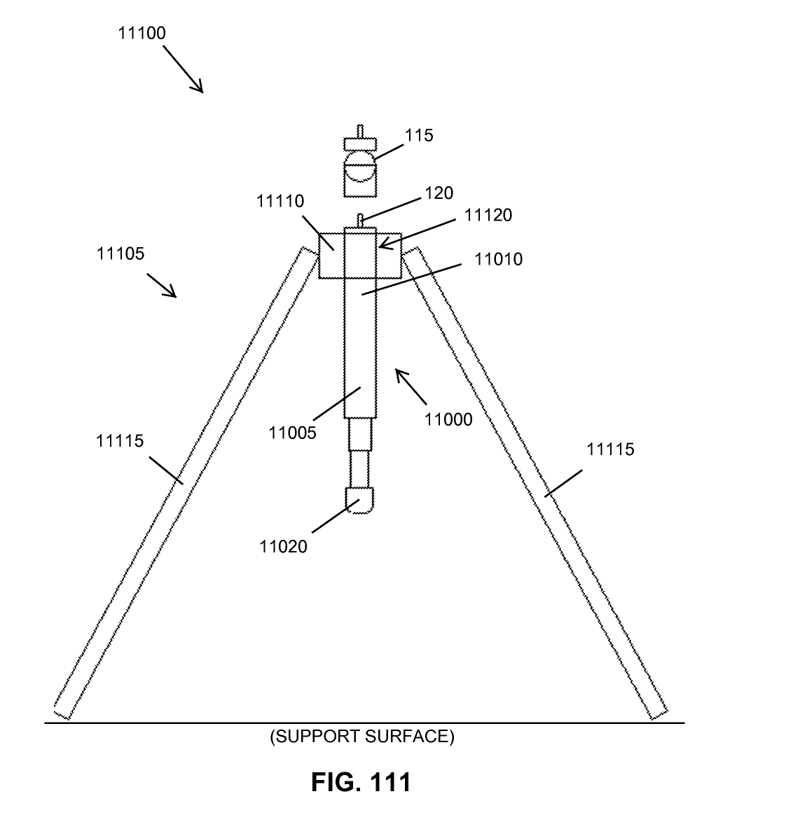

FIG. 111 illustrates a first configuration mode for a reversible monopod system 11100 using reversible monopod 11000 shown in FIG. 110. Other embodiments herein discussed have included a monopod coupled to an attachment point of a multipoint attachment body to provide a number of advantageous features and functions. Reversible monopod system 11100 includes a support system 11105 reversibly maintaining reversible monopod 11000 at a desired relationship with respect to a support surface, such as by engaging it to some portion of telescoping body 11005. In this embodiment of reversible monopod system 11100, support system 11105 includes a multipoint attachment body 11110 and one or more support legs 11115 that engage multipoint attachment body 11110 and the support surface to maintain a desired position of multipoint attachment body 11110 above the support surface. Multipoint attachment body 11110 is generally similar to multipoint attachment body 105 except that a central portion is configured to create a monopod pass-through port 11120 to reversibly and selectively accept, mount, and retain reversible monopod 11000 by mounting to one end, for example to proximal end 11010. (In some configurations, attachment may be made to some other location of reversible monopod 11000, such as distal end 11015.)

In the first configuration, telescoping body 11005 extends in a generally downward angle (most preferably directly downward to be generally perpendicular (though dependent to some degree to any slope/inclination of a support surface) to the support surface) from multipoint attachment body 11110 towards the support surface. In this simple embodiment, multipoint attachment body 11110 is part of support system 11105 which also includes one or more fixed or removable standard telescoping legs, flexlegs, or other elements forming a support structure (e.g., a tripod and the like). In some embodiment, other structural elements may be used to maintain an attachment system for reversible monopod 11000 above the support surface. Stability and usability of support system 11105 may be enhanced by a centrally-located, columnar, downwardly telescoping support provided by reversible monopod 11000, which in some uses provides extra support or another location option for placement of vertical support, or both. In some embodiments, multipoint attachment body 11110 includes a plurality of attachment points, with one or more of type 1 and/or type 2 couplers as described herein for the support system and/or accessory objects. Object coupler 115 (appropriate for coupler-type) engages attachment point 120 at proximal end 11010 for use with a desired component, imager, or other object.

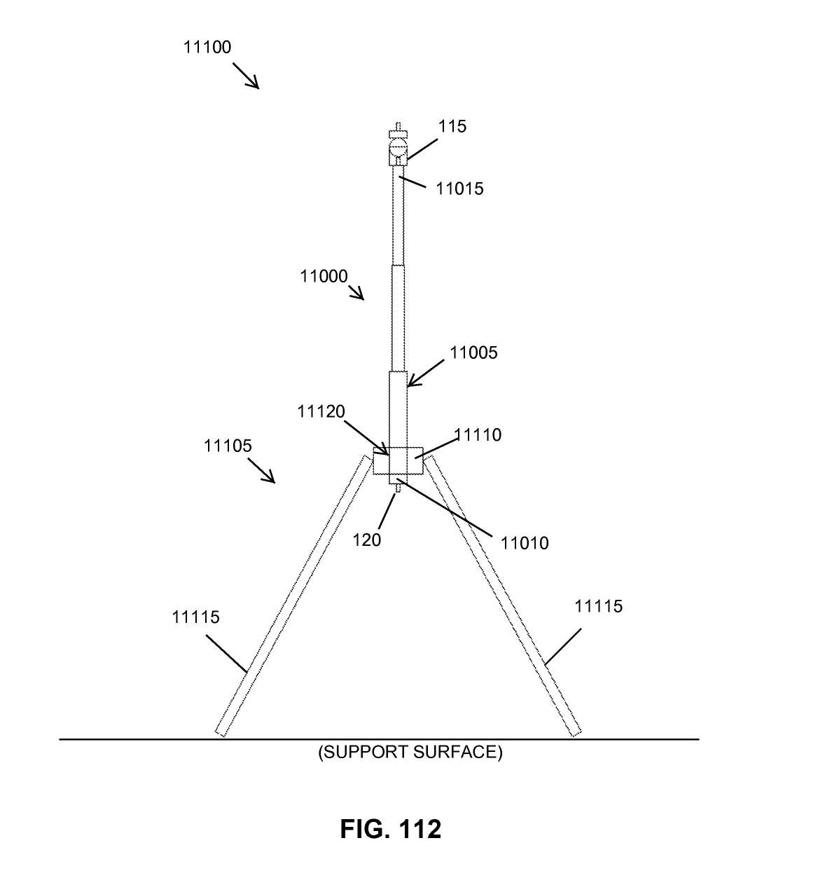

FIG. 112 illustrates a second configuration mode for reversible monopod system 11100 shown in FIG. 111. In this second configuration mode, a vertical orientation of reversible monopod 11000 is rotated 180° with respect to multipoint attachment body 11110 (and in this case, with respect to the support surface as well). Proximal end 11010 is still retained within port 11120 yet distal end 11015 now extends generally upward away y from multipoint attachment body 11110. Attachment point 120 at distal end 11015 is used to engage object coupler 115 at a selectable height above multipoint attachment body 11110. The selectable height varies by adjustment of components of reversible monopod system 11100 including telescoping body 11005 of reversible monopod 11000. Terminator 11020 may be mounted to attachment point 120 at proximal end 11010 for storage when desired.

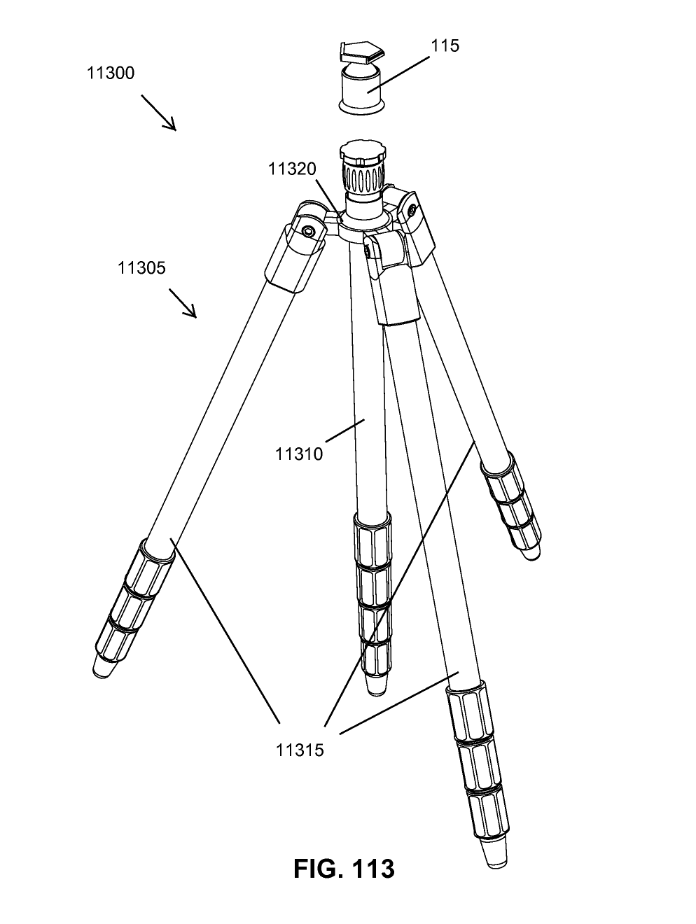

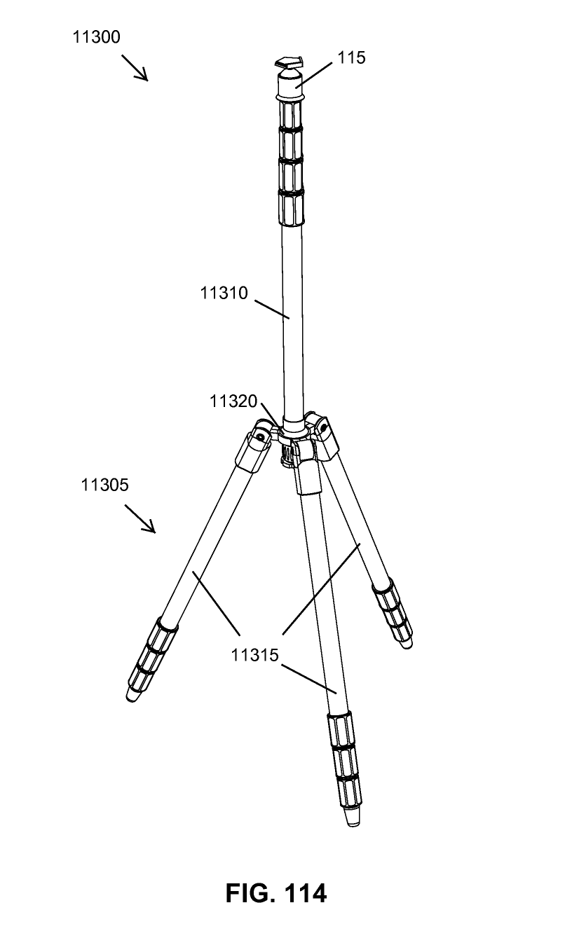

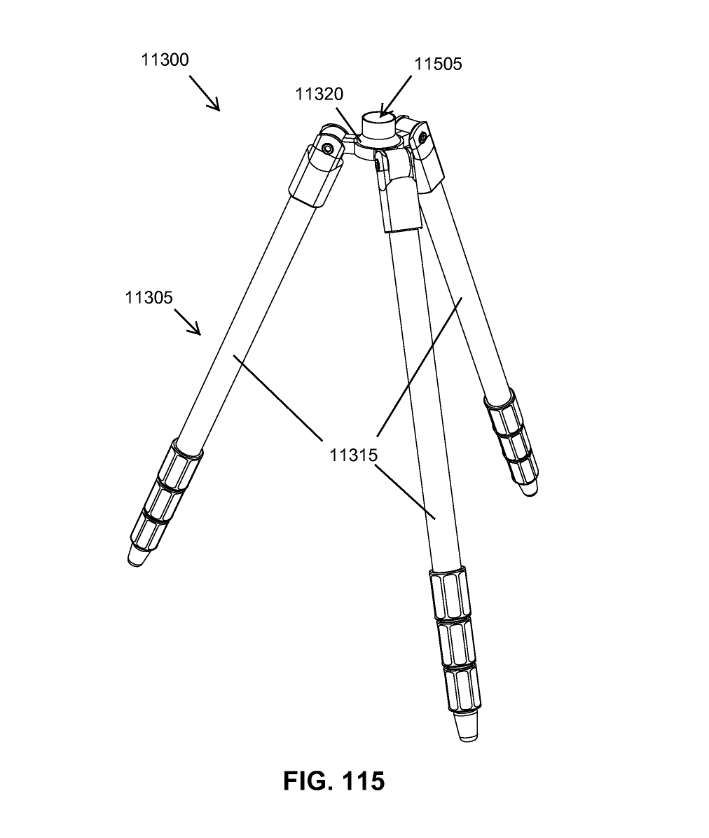

FIG. 113 illustrates a perspective view of a particular reversible monopod system 11300 in the first configuration mode, including a three-legged tripod arrangement 11305 for the support system, and FIG. 114 illustrates a perspective view of particular reversible monopod system 11300 in the second configuration mode. Particular reversible monopod system 11300 includes a reversible telescoping monopod 11310 reversibly coupled to tripod arrangement 11305. Tripod arrangement 11305 is one arrangement of support system 11105 including three telescoping tripod legs 11315 coupled to a multipoint attachment body 11320. Reversible telescoping monopod 11310 is similar to reversible monopod 11000 as it may be reversibly attached, mounted, and retained to multipoint attachment body 11320 by a proximal end with a distal end extending downwardly (FIG. 113) or upwardly (FIG. 114). In this fashion, the mechanism for reversible attachment of reversible telescoping monopod 11310 to multipoint attachment body 11320 engages the proximal similar to reversible monopod 11000 engagement to multipoint attachment body 11110 (including use of object coupler 115 engaging a coupler at an attachment point at the proximal end (FIG. 113) or the distal end (FIG. 114). FIG. 115 illustrates a perspective view of the three-legged tripod arrangement shown in FIG. 113 and FIG. 114 without installation of reversible monopod 11310. In this view, a pass-through port 11505 in multipoint attachment body 11320 is more clearly seen. As noted herein, there are many mechanical coupling mechanisms that are available to reversibly mount a reversible monopod in a pass-through port. The mounting system provides secure attachment allowing the reversible monopod to help provide stability/support vis-à-vis a support surface in the first configuration (and/or providing a more compact arrangement for portability/storage) while providing a height-adjustable object mount in the second configuration.

The embodiments of the reversible monopod and the reversible monopod system are not limited to the types of implementations shown in FIG. 110-FIG. 115. As noted, the monopod and monopod systems may include attachment points and couplers and other components as shown in FIG. 1-FIG. 109. For example, a multipoint attachment body such as body 105 may be coupled to either end of the reversible monopod as a stand-alone reconfigurable reversible monopod or as a reconfigurable reversible monopod system. Such a body may be used in lieu of coupler 115 or in addition to coupler 115, with coupler 115 joined to an attachment point of body 105 and either end of the reversible monopod coupled to an attachment point of body 105, such as by use of a coupler at an underside central attachment point. Additional elements, flexlegs, terminators, and the like may be joined to any of the attachment points by use of appropriate/suitable couplers (such as those identified as type 1 and compatible type 2 couplers).

There are many possible ways known in the art to securely mount and retain a telescoping columnar body to a support system, the specifics of the precise mounting and retention system are not limiting to the present invention. Some variation occurs based upon the application, telescoping body, and support system.

### SUMMARY

The system and methods above has been described in general terms as an aid to understanding details of preferred embodiments of the present invention. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An object coupler providing a three-type multi-method mount for a device, comprising:
a housing defining a first attachment point and a second attachment point;
a fixed coupler coupled to said first attachment point, said fixed coupler engageable with a mount;
a connector coupled to said second attachment point and configured to engage the device; and
a moveable coupler moveably coupled to said housing having a range of motion relative to said fixed coupler, said range of motion including a capability of movement between a first location and a second location, said first location at a first lateral side of said housing and said second location at a second lateral side of said housing whenever said fixed coupler is not engaged with said mount and wherein said locations are constrained to one of said lateral sides whenever said fixed coupler is engaged with said mount.

2. The object coupler of claim 1 wherein said capability of movement includes a movement of said moveable coupler past a fixed coupler interference position with respect to said fixed coupler, said fixed coupler interference position inhibiting said fixed coupler from engaging said mount when said moveable coupler is located at said fixed coupler interference position.

3. The object coupler of claim 1 wherein said moveable coupler is a ring pivotally coupled to an exterior wall of said housing.

4. The object coupler of claim 3 wherein said exterior wall includes an elongate cylindrical wall extending from said first attachment point to said second attachment point.

5. The object coupler of claim 1 wherein the device includes a mounting system, wherein said connector is complementary to said mounting system, and wherein said fixed coupler is a quick connect connector.

6. The object coupler of claim 5 wherein said mounting system includes a ¼″ threaded socket and wherein said connector complementary to said mounting system includes a ¼″ threaded bolt.

7. The object coupler of claim 5 wherein said quick connect connector is a type 2 connector.

8. A method for coupling to a device having a mounting system, comprising:
a) engaging the device with a connector complementary to the mounting system, said connector coupled to a first attachment point of a housing wherein a moveable coupler is moveably coupled to an exterior wall of said housing;
b) coupling a fixed coupler at a second attachment point of said housing to a mount which constrains a range of motion of a moveable coupler to one lateral side of said housing; and thereafter
c) disengaging said fixed coupler from said mount which unconstrains said range of motion permitting said moveable coupler to move from one lateral side of said housing to another lateral side past said fixed coupler.
